(19) United States
(12) Patent Application Publication
(10) Pub. No.: US 2022/0331803 A1
(43) Pub. Date: Oct. 20, 2022

(54) Devices and Systems for Non-Destructive Collection and Monitoring of Biological Volatiles

(71) Applicants: Barbara Smith, Mesa, AZ (US); Jarrett Eshima, Phoenix, AZ (US); Joel Lusk, Mesa, AZ (US); Benjamin Ambrose, Scottsdale, AZ (US)

(72) Inventors: Barbara Smith, Mesa, AZ (US); Jarrett Eshima, Phoenix, AZ (US); Joel Lusk, Mesa, AZ (US); Benjamin Ambrose, Scottsdale, AZ (US)

(73) Assignee: Arizona Board of Regents on behalf of Arizona State University, Scottsdale, AZ (US)

(21) Appl. No.: 17/715,352

(22) Filed: Apr. 7, 2022

Related U.S. Application Data
(60) Provisional application No. 63/171,662, filed on Apr. 7, 2021.

(51) Int. Cl. B01L 3/00

(52) U.S. Cl. CPC B01L 3/502776; B01L 3/569; B01L 3/561; B01L 2300/0832

(57) ABSTRACT

A collection device for collecting volatile organic compounds (VOCs) from a living biological sample is disclosed. The collection device comprises a housing defining an interior chamber and an inlet and outlet each fluidly communicating with the interior chamber. The housing is formed by an upper surface, a lower surface, and a substantially circular sidewall extending between the upper and lower surfaces. The interior chamber comprises a substantially cylindrical volume enclosed by the housing and configured to receive the living biological sample. The inlet and the outlet may extend through the upper surface and may be substantially diametrically opposed with respect to the circular sidewall. The collection device may be configured to pass fluid in a substantially laminar flow path through the inlet, across the interior chamber, and out of the outlet. At least a portion of the housing may comprise a substantially transparent material configured to transmit light therethrough.

### CROSS-REFERENCE TO RELATED APPLICATIONS

This application claims priority to U.S. Provisional Patent Application No. 63/159,712, filed Apr. 7, 2021, the contents of which are each incorporated by reference herein in their entirety.

### TECHNICAL FIELD

The present disclosure relates generally to devices and systems related to collection of volatile organic compounds from living organisms. The disclosed techniques may be applied to various tissues as a research tool (e.g., studying and identifying biomarkers) and/or a clinical tool (e.g., diagnosis and/or prognosis based on detection of biomarkers amongst the volatile organic compounds).

### BACKGROUND

Volatile organic compounds (VOCs) contain a wealth of untapped information related to the active metabolic processes of organisms. Recently, interest has grown with regards to the potential of VOCs to be used in both research and clinical applications as biomarkers for cancer, infection, organ damage, and/or organ failure. For example, detection of VOCs may allow for metabolite detection during biological and/or chemical reactions within an organism. Thus, VOCs may be studied through biological models for cancer, infection, and/or organ function in order to identify novel biomarkers for diagnosis and/or prognosis of various conditions. For example, ovarian cancer is a highly aggressive disease with a rapid progression that results in an advanced stage diagnosis for over 70% of patients. Accordingly, ovarian cancer diagnosis, prognosis, and treatment would benefit from a tool for early stage detection.

However, difficulties associated with collecting VOCs pose a barrier to their use for studying metabolic processes of organisms. Current approaches for capturing volatiles from organisms typically involve destruction of cells in order to access and obtain VOCs from within the organism. However, destruction of the cells limits the types of analysis that may be performed on the organisms. For example, comparative analysis of an organism over a period of time and/or follow-up experiments on the same organism may not be possible where the process for obtaining VOCs requires destruction of cells.

Specialized devices and/or systems for capturing volatiles from living organisms without destroying cells are not currently available. Makeshift devices or systems for non-destructively capturing VOCs may involve non-standardized sampling procedures and may lead to results that are suboptimal and/or difficult to reproduce.

As such, it would be advantageous to have a system for non-destructive collection of VOCs while maintaining an environment favorable for organism survival and growth.

### SUMMARY

A collection device for collecting VOCs from a living biological sample is provided. The collection device comprises a housing comprising an upper surface, a lower surface, and a substantially circular sidewall extending between the upper surface and the lower surface; an interior chamber comprising a substantially cylindrical volume defined between the upper surface, the lower surface, and the circular sidewall, wherein the interior chamber is configured to receive the living biological sample; one or more inlets extending through the upper surface and fluidly communicating with the interior chamber; and one or more outlets extending through the upper surface and fluidly communicating with the interior chamber, wherein the one or more outlets is substantially diametrically opposed to the one or more inlets with respect to the cylindrical volume, wherein the collection device is configured to pass fluid in a substantially laminar flow path through the one or more inlets, across the interior chamber, and out of the one or more outlets, wherein at least one of the upper surface, the lower surface, and the circular sidewall comprises a substantially transparent material configured to transmit light therethrough.

According to some embodiments, the one or more inlets are disposed about 0.4 cm from the circular sidewall and have a diameter of about 0.635 cm (¼ in).

According to some embodiments, the one or more outlets are disposed about 1.0 cm from the circular sidewall and have a diameter of about 1.8 cm.

According to some embodiments, one or more ports extend through the upper surface and fluidly communicating with the interior chamber.

According to some embodiments, the port is disposed about 1.0 cm from the circular sidewall and has a diameter of about 1.25 cm. According to some embodiments, each of the inlets and the outlets comprises a tubular channel having a height of about 1 cm extending upward from the upper surface.

According to some embodiments, the one or more ports comprises a tubular channel extending through the upper surface and fluidly communicating with the interior chamber.

According to some embodiments, the collection device further comprises an inlet cap including one or more openings configured to permit fluid flow through the one or more inlets.

According to some embodiments, the collection device further comprises outlet caps including one or more openings configured to permit fluid flow through the one or more outlets.

According to some embodiments, the collection device further comprises one or more ports each with an opening configured to permit interaction with the interior chamber through the port.

According to some embodiments, the housing is configured to withstand autoclaving.

According to some embodiments, the housing is heat-treated to reduce background VOC release.

According to some embodiments, the substantially transparent material comprises borosilicate glass.

According to some embodiments, the cylindrical volume comprises a diameter of about 6.8 cm and a height of about 1.3 cm.

A fluid flow system for collecting VOCs from a living biological sample is also provided. The fluid flow system comprises a collection device including: a housing comprising an upper surface, a lower surface, and a substantially circular sidewall extending between the upper surface and the lower surface, an interior chamber comprising a substantially cylindrical volume defined between the upper surface, the lower surface, and the circular sidewall, wherein the interior chamber is configured to receive the living biological sample, one or more inlets extending through the upper surface and fluidly communicating with the interior chamber; and one or more outlets extending through the upper surface and fluidly communicating with the interior chamber, wherein the one or more outlets is substantially diametrically opposed to the one or more inlets with respect to the cylindrical volume; a compressed gas source in fluid communication with the interior chamber of the collection device via the one or more inlets and configured to emit gas to the interior chamber to displace a volume of headspace from the interior chamber; a fluid flow meter in fluid communication with the compressed gas source and the interior chamber, the fluid flow meter configured to regulate a flow rate of gas from the compressed gas source to the interior chamber; and a one or more thermal desorption tube in fluid communication with the interior chamber via the one or more outlet, the thermal desorption tube configured to collect the displaced volume of headspace from the interior chamber and capture VOCs from the displaced volume of headspace, wherein the gas emitted to the interior chamber and the volume of headspace displaced from the interior chamber flow along a substantially laminar flow path through the interior chamber.

According to some embodiments, the inlet is disposed about 0.4 cm from the circular sidewall and has a diameter of about 0.635 cm (¼ in).

According to some embodiments, the outlet is disposed about 1.0 cm from the circular sidewall and has a diameter of about 1.8 cm.

According to some embodiments, the one or more ports is disposed about 1.0 cm from the circular sidewall and has a diameter of about 1.25 cm.

According to some embodiments, each of the inlet and the outlet comprises a tubular channel having a height of about 1 cm extending upward from the upper surface.

According to some embodiments, the one or more ports comprises a tubular channel extending through the upper surface and fluidly communicating with the interior chamber.

According to some embodiments, the fluid flow system further comprises an inlet cap including one or more openings configured to permit fluid flow through the inlet.

According to some embodiments, the fluid flow system further comprises an outlet cap including one or more openings configured to permit fluid flow through the outlet.

According to some embodiments, at least one of the upper surface, the lower surface, and the circular sidewall comprises a substantially transparent material configured to transmit light therethrough. According to further embodiments, the substantially transparent material comprises borosilicate glass.

According to some embodiments, the housing is configured to withstand autoclaving.

According to some embodiments, the housing is heat-treated to reduce background VOC release.

According to some embodiments, the fluid flow system further comprises a hydrocarbon trap in fluid communication with the compressed gas source and the interior chamber, the hydrocarbon trap configured to remove hydrocarbon impurities from the gas upstream of the interior chamber.

According to some embodiments, the compressed gas source comprises a mixture of gases.

According to some embodiments, the fluid flow meter is configured to regulate the flow rate at about 10 mL/min to 50 mL/min.

According to some embodiments, the collection device is disposed in a bath, wherein the bath is configured to maintain the temperature in the interior chamber.

According to some embodiments, the collection device, the compressed gas source, the fluid flow meter, and the thermal desorption tube are connected by one or more polytetrafluoroethylene (PTFE) tubes.

According to some embodiments, the cylindrical volume comprises a diameter of about 6.8 cm and a height of about 1.3 cm.

According to some embodiments, the fluid flow system further comprises a multiplexing device in fluid communication with the compressed gas source and one or more interior chambers of collection devices, the multiplexing device configured to allow for the compressed gas source to be distributed across one or more collection devices for conducting multiple experiments in parallel.

According to some embodiments, the multiplex part is comprised of one or more inlets and one or more outlets for connection to, and subsequent distribution of, a compressed gas source.

According to some embodiments, the one or more inlets of the multiplexing device has a diameter of about 0.635 cm (¼ in).

According to some embodiments, the one or more outlets of the multiplexing device has a diameter of about 0.635 cm (¼ in).

### BRIEF DESCRIPTION OF THE DRAWINGS

The accompanying drawings, which are incorporated in and form a part of the specification, illustrate the embodiments of the technology and together with the written description serve to explain the principles, characteristics, and features of the technology. In the drawings:

FIG. 1A depicts a collection device for collecting VOCs in accordance with an embodiment.

FIG. 1B depicts a top view of the collection device of FIG. 1A in accordance with an embodiment.

FIG. 1C depicts a vertical cross-sectional view of the collection device of FIG. 1A in accordance with an embodiment.

FIG. 1D depicts a perspective view of the collection device of FIG. 1A in accordance with an embodiment.

FIG. 1E-1H depict perspective views for the collection device of FIG. 1A with varying configurations of inlets and outlets in accordance with additional embodiments.

FIG. 2 depicts a fluid flow system for collecting volatile organic compounds (VOCs) in accordance with an embodiment.

FIG. 3A-3B depicts a perspective view and side view, respectively, of a multiplexing part in accordance with an embodiment.

FIG. 3C depicts a multiplexing system for parallel experimentation using a multiplexing part of FIG. 3A and one or more collection device of FIG. 1A in accordance with an embodiment.

FIGS. 4A-4B depict a side view and top view, respectively, of exemplary fluid flow profiles in a collection device in accordance with an embodiment.

FIGS. 4C-4F depict exemplary pressure and velocity profile data through the center of a collection device in accordance with an embodiment.

FIGS. 5A-5E depict exemplary fluid flow profiles at various flow rates in a collection device with updated geometry in accordance with an embodiment.

FIGS. 6A-6L depict the exemplary fluid flow profile and associated pressure and velocity profiled data through a collection device with varying configurations of inlets and outlets in accordance with an embodiment.

FIG. 7A-7L depict exemplary fluid flow profile and associated pressure and velocity profile data through the center of a multiplex part in accordance with an embodiment.

FIGS. 8A-8B depict exemplary 3D chromatograms generated from thermal desorption tubes containing VOCs collected with a collection device in accordance with an embodiment.

FIGS. 9A-9I depict exemplary volatile organic compound abundance results for several detected VOCs across multiple samples in accordance with an embodiment.

FIGS. 10A-10G depict exemplary results of a live/dead assay for a cell culture performed through a collection device in accordance with an embodiment.

FIG. 11 depicts exemplary surface adhesion data for various surface treatments of a collection device in accordance with an embodiment.

FIGS. 12A-12D depict exemplary chromatograms generated from thermal desorption tubes containing VOCs collected with a collection device in accordance with an embodiment.

FIGS. 13A-13D depict exemplary chromatograms generated from thermal desorption tubes containing VOCs collected with a collection device in accordance with an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope. Such aspects of the disclosure be embodied in many different forms; rather, these embodiments are provided so that this disclosure will be thorough and complete, and will fully convey its scope to those skilled in the art.

As used in this document, the singular forms “a,” “an,” and “the” include plural references unless the context clearly dictates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As will be understood by one skilled in the art, for any and all purposes, such as in terms of providing a written description, all ranges disclosed herein are intended as encompassing each intervening value between the upper and lower limit of that range and any other stated or intervening value in that stated range. All ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells as well as the range of values greater than or equal to 1 cell and less than or equal to 3 cells. Similarly, a group having 1-5 cells refers to groups having 1, 2, 3, 4, or 5 cells, as well as the range of values greater than or equal to 1 cell and less than or equal to 5 cells, and so forth.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

By hereby reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by hereby reserving the right to proviso out or exclude any individual substituents, structures, or groups thereof, or any members of a claimed group, less than the full measure of this disclosure can be claimed for any reason.

All percentages, parts and ratios of a composition are based upon the total weight of the composition and all measurements made are at about 25° C., unless otherwise specified.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art. Where the context of the disclosure indicates otherwise, or is inconsistent with such an interpretation, the above-stated interpretation may be modified as would be readily apparent to a person skilled in the art. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). Further, the transitional term “comprising,” which is synonymous with “including,” “containing,” or “characterized by,” is inclusive or open-ended and does not exclude additional, unrecited elements or method steps. While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

The terms “patient” and “subject” are interchangeable and refer to any living organism which contains neural tissue. As such, the terms “patient” and “subject” may include, but are not limited to, any non-human mammal, primate or human. A subject can be a mammal such as a primate, for example, a human. The term “subject” includes domesticated animals (e.g., cats, dogs, etc.); livestock (e.g., cattle, horses, swine, sheep, goats, etc.), and laboratory animals (e.g., mice, rabbits, rats, gerbils, guinea pigs, possums, etc.). In some embodiments, the patient or subject is an adult, child, or infant. In some embodiments, the patient or subject is a human.

The term “tissue” refers to any aggregation of similarly specialized cells which are united in the performance of a particular function.

The term “disorder” is used in this disclosure to mean, and is used interchangeably with, the terms “disease,” “condition,” or “illness,” unless otherwise indicated.

The term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

Throughout this disclosure, various patents, patent applications and publications are referenced. The disclosures of these patents, patent applications and publications are incorporated into this disclosure by reference in their entireties in order to more fully describe the state of the art as known to those skilled therein as of the date of this disclosure. This disclosure will govern in the instance that there is any inconsistency between the patents, patent applications and publications cited and this disclosure.

As discussed herein, it would be advantageous to have a system for non-destructive collection of VOCs while maintaining an environment favorable for organism survival and growth. Ideally, the system can maintain a controlled environment to monitor and collect volatile metabolic changes in living systems. In some embodiments, the system may be relevant to research applications such as disease modeling (e.g., lung cancer modeling), infection modeling (e.g., lung infection modeling), breath analysis, microbiological modeling, bacteria and/or fungi interactions, and the like. In some embodiments, the system may have clinical applications such as early stage biomarker detection for disease and/or organ damage or failure.

### Collection Device for Volatile Organic Compounds

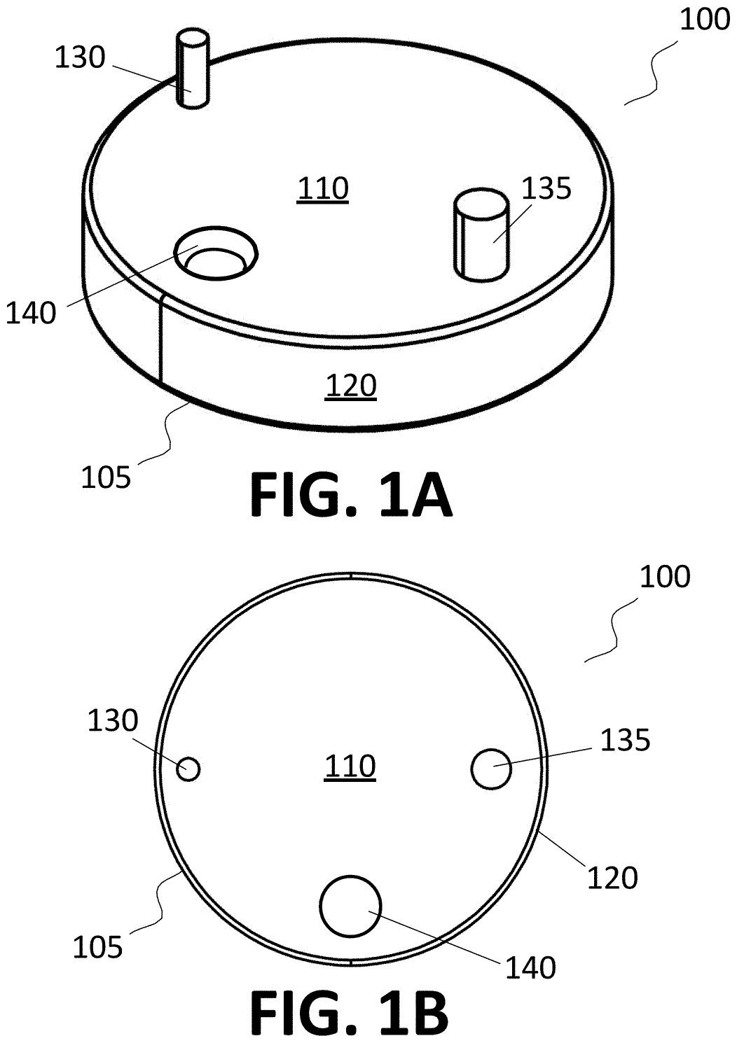

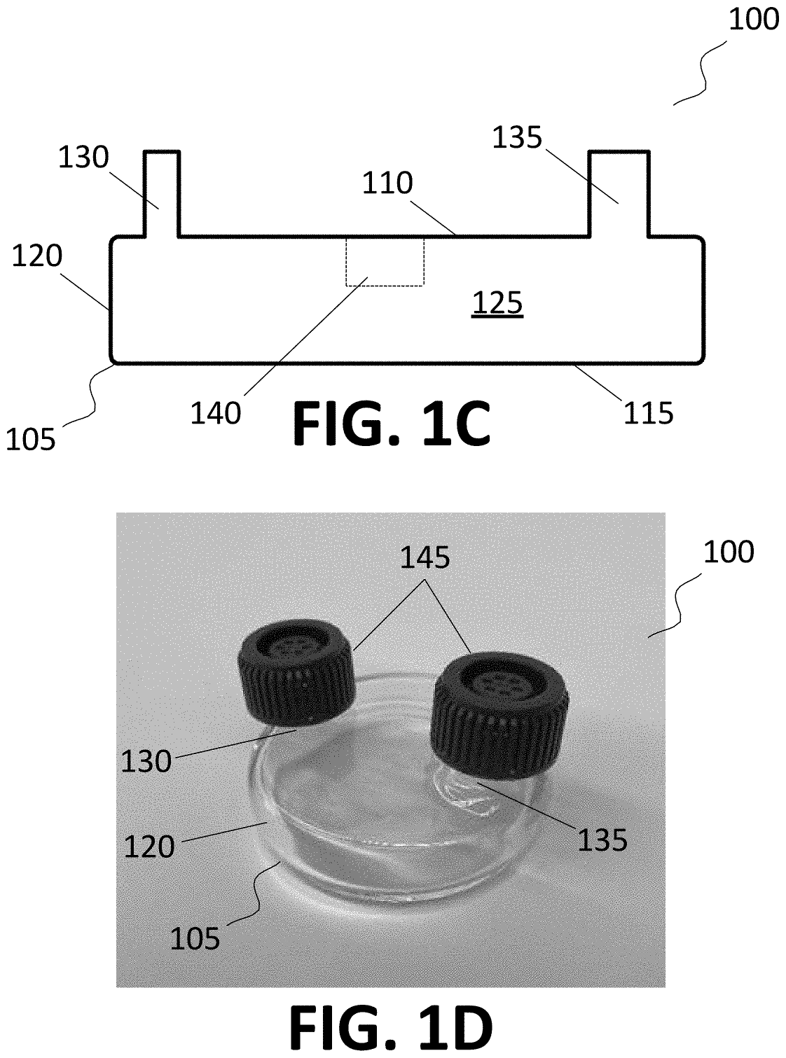

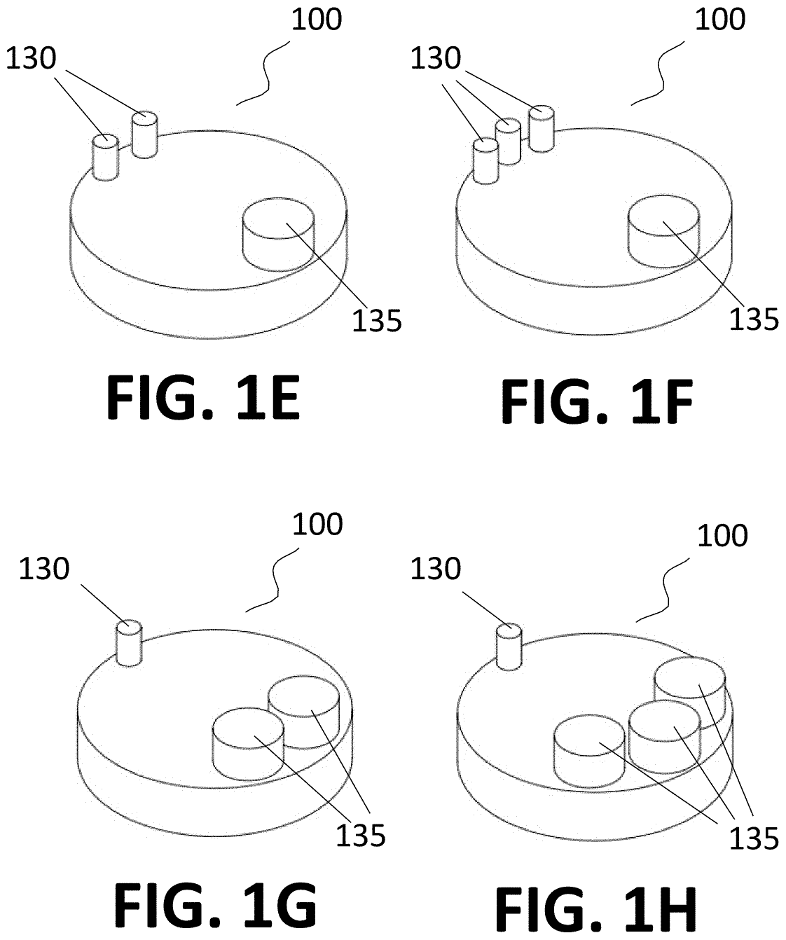

FIG. 1 depicts a perspective view of a collection device for collecting volatile organic compounds (VOCs) in accordance with an embodiment. FIG. 1B depicts a top view of the collection device in accordance with an embodiment. FIG. 1C depicts a vertical cross-sectional view of the collection device in accordance with an embodiment. FIG. 1D depicts an additional perspective view of the collection device in accordance with an embodiment. Similar features within FIGS. 1-3 are identified with common reference numbers. The collection device 100 may also be referred to as a “biodome.”

As shown in FIGS. 1A-1D, the collection device 100 comprises a housing 105, and interior chamber 125, and inlet 130, and an outlet 135. The collection device 100 may be configured to pass fluid in a substantially laminar flow path through the inlet, across the interior chamber, and out of the outlet.

The housing 105 may comprise an upper surface 110, and lower surface 115, and a sidewall 120 extending between the upper surface 110 and the lower surface 115. The upper surface 110 and the lower surface 115 may be substantially parallel and may be positioned on opposing sides of the sidewall 120 from one another, i.e., above and below the sidewall 120, respectively. The upper surface 110 may be joined to an upper edge of the sidewall 120 and the lower surface 115 may be joined to a lower edge of the sidewall 120 such that the housing 105 forms an enclosure.

As shown in FIGS. 1A-1B, the sidewall 120 may be substantially circular in shape. For example, a horizontal cross-section of the sidewall 120 may form a substantial circle that defines a circumference of the housing 105. In some embodiments, the upper surface 110 and the lower surface 115 may also be substantially circular in shape (i.e., in a horizontal cross-section) and may be sized in a manner corresponding to the sidewall 120. However, the upper surface 110 and the lower surface 115 may comprise a variety of sizes and shapes. For example, the upper surface 110 and/or the lower surface 115 may have a diameter greater than the sidewall 120 and may extend beyond the sidewall 120 in one or more directions such that the upper surface 110, lower surface 115, and sidewall 120 nonetheless cooperate to form an enclosure.

The interior chamber 125 may be defined and enclosed by the upper surface 110, the lower surface 115, and the sidewall 120. In some embodiments, the interior chamber 125 comprises a substantially cylindrical volume of space. The volume of the interior chamber 125 may be defined by a diameter of the interior chamber 125 and a height of the interior chamber 125, which may be substantially equal to an inner diameter of the sidewall 120 and a height of the sidewall 120 (i.e., a distance between the upper surface 110 and the lower surface 115).

In some embodiments, the interior chamber 125 is configured to facilitate substantially laminar flow therethrough as further described herein. Accordingly, the diameter and the height of the interior chamber 125 may be selected to facilitate substantially laminar flow. In some embodiments, the height of the interior chamber 125 may be about 1.3 cm. In some embodiments, the height of the interior chamber 125 may be about 0.25 cm (i.e., about 2.5 mm) to about 3.5 cm. However, it is contemplated that additional heights that facilitate substantially laminar flow may be used for the interior chamber 125. For example, the height of the interior chamber may be about 0.05 cm (i.e., about 0.5 mm), about 0.1 cm (i.e., about 1 mm), about 0.5 cm (i.e., about 5 mm), about 1 cm, about 1.3 cm, about 1.5 cm, about 1.7 cm, about 2 cm, about 3 cm, about 4 cm, about 5 cm, about 10 cm, about 20 cm, about 30 cm, about 30.5 cm (i.e., about 1 ft), greater than about 30.5 cm, or individual values or ranges therebetween. In some embodiments, the diameter of the interior chamber 125 may be about 6.8 cm. In some embodiments, the diameter of the interior chamber 125 may be about 3 cm to about 20 cm. However, it is contemplated that additional diameters that facilitate substantially laminar flow may be used for the interior chamber 125. For example, the diameter of the interior chamber may be about 1 cm, about 2 cm, about 3 cm, about 4 cm, about 5 cm, about 6 cm, about 6.5 cm, about 6.8 cm, about 7 cm, about 7.2 cm, about 7.5 cm, about 8 cm, about 9 cm, about 10 cm, about 15 cm, about 20 cm, about 25 cm, about 30 cm, about 30.5 cm (i.e., about 1 ft), greater than about 30.5 cm, or individual values or ranges therebetween.

In some embodiments, the edges of the interior chamber 125, i.e., the junction of the sidewall 120 with the upper surface 110 and/or the lower surface 115, may be rounded. For example, the rounded edges may have a radius of curvature of about 1.0. However, other curvatures may be used herein, e.g., about 0.5, about 1.0, about 1.5, about 2.0, greater than about 2.0, or individual values or ranges therebetween. In some embodiments, the curvature may extend about 1 mm. However, the curvature may be about 0.5 mm, about 1 mm, about 1.5 mm, about 2 mm, greater than about 2 mm, or individual values or ranges therebetween.

In some embodiments, the interior chamber 125 may have a predetermined ratio between the diameter and the height thereof in order to facilitate laminar flow therethrough. In some embodiments, lower surface area to volume ratio of the chamber may result in detection of a greater number of VOCs. However, it should be understood that the dimensions of the collection device 100, including the interior chamber 125, may be scaled with only minor modifications to perform larger experiments without substantially affecting the laminar flow through the interior chamber 125.

Referring once again to FIGS. 1A-1C, the inlet 130 and the outlet 135 may extend through the upper surface 110 and fluidly communicate with the interior chamber 125. However, in some embodiments, the inlet 130 and/or the outlet 135 may extend through the lower surface 115. The inlet 130 and/or the outlet 135 may extend transverse (e.g., substantially perpendicular) to the circular cross-section of the sidewall 120 and/or the interior chamber 125.

In some embodiments, the inlet 130 and/or the outlet 135 may each be formed as a tubular channel extending from the upper surface 110. In some embodiments, the inlet 130 and/or the outlet 135 may extend above the upper surface 110 by a height of about 1 cm. However, it is contemplated that additional heights may be used for the inlet 130 and/or the outlet 135. For example, the height of the inlet 130 and/or the outlet 135 may be about 0.1 cm (i.e., about 1 mm), about 0.5 cm (i.e., about 5 mm), about 1 cm, about 2 cm, about 3 cm, greater than about 3 cm, or individual values or ranges therebetween. In some embodiments, the inlet 130 and/or the outlet 135 may also be formed as apertures through the upper surface 110 without an upwardly extending structure. It should also be understood that the inlet 130 and/or the outlet 135 may additionally or alternatively be disposed through the lower surface 115 and/or the sidewall 120 in a manner that maintains the substantially laminar flow through the interior chamber as described herein. In some embodiments, a plurality of inlets 130 and/or outlets 135 may be provided on the collection device 100.

The inlet 130 and/or the outlet 135 may be formed in a variety of shapes and/or sizes to facilitate mating with various types of tubing and/or connectors therewith. In some embodiments, the inlet 130 and/or the outlet 135 may include mating features, e.g., threads, ridges, grooves, and/or the like to allow coupling of tubing and/or connectors as would be known to a person having an ordinary level of skill in the art.

In some embodiments, the inlet 130 may have a diameter (i.e., an inner diameter of the tubular channel) of about 4 mm. However, it is contemplated that additional diameters may be used for the inlet 130 to permit coupling of tubing with the inlet 130 and to facilitate substantially laminar flow into and through the interior chamber 125 as described. For example, the diameter of the inlet 130 may be about 1 mm, about 2 mm, about 3 mm, about 4 mm, about 5 mm, about 6 mm, about 7 mm, about 8 mm, about 9 mm, about 1 cm, about 2 cm, about 3 cm, greater than about 3 cm, or individual values or ranges therebetween.

In some embodiments, the tubular channel forming the inlet 130 may have a thickness of about 1 mm. For example, where the inlet 130 has diameter of about 4 mm, the tubular channel may have an outer diameter of about 6 mm or about 6.35 mm (i.e., about ¼ inch). Accordingly, the inlet 130 may be configured to receive ¼ inch tubing thereon. However, additional thicknesses as described for the housing 105 are also contemplated herein for the inlet 130.

In some embodiments, the outlet 135 may have a diameter (i.e., an inner diameter of the tubular channel) of about 7 mm. However, it is contemplated that additional diameters may be used for the outlet 135 to permit coupling of a rubber stopper, a thermal desorption tube, solid phase micro-extraction (SPME) fibers and/or tubing with the outlet 135 and to facilitate substantially laminar flow through and out of the interior chamber 125 as described. For example, the diameter of the outlet 135 may be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 10 cm, greater than 10 cm, or individual values or ranges therebetween.

In some embodiments, the tubular channel forming the outlet 135 may have a thickness configured to fit a rubber stopper, tubing, and/or a metal nut assembly thereon. In some embodiments, the tubular channel may have a thickness of about 5 mm or about 5.5 mm. For example, where the outlet 135 has diameter of about 7 mm, the tubular channel may have an outer diameter of about 1.8 cm. Accordingly, the outlet 135 may be configured to receive a rubber stopper, PTFE tubing, and/or a metal nut assembly thereon to form a seal between the outlet 135 and a thermal desorption tube or SPME fibers as further described herein. However, additional thicknesses as described for the housing 105 are also contemplated herein for the outlet 135.

In some embodiments, the inlet 130 and the outlet 135 may be diametrically opposed with respect to the interior chamber 125, i.e., arranged along a diameter of the interior chamber 125 with the center of the interior chamber located directly therebetween as shown in FIG. 1B. Thus, a center of the inlet 130, the center of the interior chamber 125, and a center of the outlet 135 may be arranged in a single vertical plane (or in a single line when viewed in a horizontal cross-section). In some embodiments, the inlet 130 and the outlet 135 may be arranged at substantially opposite ends of the diameter of the interior chamber 125 and/or proximate the sidewall 120 as shown in FIGS. 1B-1C. In some embodiments, the inlet 130 is disposed from the sidewall 120 and/or the perimeter of the interior chamber 125 by about 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, or greater than 30 mm, or individual values or ranges there between. For example, the inlet 130 may be arranged about 0.4 cm from the sidewall 120 and/or the perimeter of the interior chamber 125. In some embodiments, the outlet 135 is disposed from the sidewall 120 and/or the perimeter of the interior chamber 125 by about 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, or greater than 30 mm, or individual values or ranges therebetween. For example, the outlet 135 may be arranged about 1.0 cm from the sidewall 120 and/or the perimeter of the interior chamber 125. However, these values may be adjusted in a manner that maintains laminar flow through the interior chamber 125 as would be understood by a person having an ordinary level of skill in the art. In additional embodiments, the inlet 130 and the outlet 130 may be symmetrically arranged on the collection device 100, i.e., a center of the inlet 130 and a center of the outlet 135 may be substantially equidistant from the center of the interior chamber 125 and/or from the sidewall 120.

As shown in FIGS. 1E-1H, the collection device 100 may be comprised of one or more inlets 130 and/or one or more outlets 135. In one embodiment, the collection device is comprised of two inlets 130 and one outlet 135 as shown in FIG. 1E. In one embodiment, the collection device is comprised of three inlets 130 and one outlet 135 as shown in FIG. 1F. In one embodiment, the collection device is comprised of one inlet 130 and two outlets 135 as shown in FIG. 1G. In one embodiment, the collection device is comprised of one inlet 130 and three outlets 135 as shown in FIG. 1H. In one embodiment, the collection device 100 may be comprised of three inlets 130 and three outlets 135. In some embodiments, the collection device 100 may be comprised of more than three inlets 130, and/or more than three outlets 135. In some embodiments, the number of inlets 130 and the number of outlets 135, and any combination thereof on collection device 100 could be determined by a person having an ordinary level of skill in the art.

In certain embodiments device 100 further comprises one or more ports 140 to provide access to the interior chamber 125 of device 100. In one embodiment, the port extends through the upper surface 110 and provides an opening to the system 100 for the entry and/or exit of material from the interior chamber 125. Referring once again to FIGS. 1A-1C, the port 140 may extend through the upper surface 110 and fluidly communicate with the interior chamber 125. However, in some embodiments, the port 140 may extend through the lower surface 115. In some embodiments, the port 140 may extend transverse (e.g., substantially perpendicular) to the circular cross-section of the sidewall 120 and/or the interior chamber 125.

In some embodiments, the port 140 may be formed as a tubular channel extending from the upper surface 110. In some embodiments, the port 140 may extend above the upper surface 110 by a height of about 1 cm. However, it is contemplated that additional heights may be used for the port 140. For example, the height of the port 140 may be about 0.1 cm (i.e., about 1 mm), about 0.5 cm (i.e., about 5 mm), about 1 cm, about 2 cm, about 3 cm, greater than about 3 cm, or individual values or ranges therebetween. In some embodiments, the port 140 may also be formed as apertures through the upper surface 110 without an upwardly extending structure. It should also be understood that the port 140 may additionally or alternatively be disposed through the lower surface 115 and/or the sidewall 120 in a manner that does not inhibit the substantially laminar flow through the interior chamber as described herein. In some embodiments, a plurality of ports 140 may be provided on the collection device 100.

The port 140 may be formed in a variety of shapes and/or sizes to facilitate mating with various types of tubing and/or connectors therewith. In some embodiments, the port 140 may include mating features, e.g., threads, ridges, grooves, and/or the like to allow coupling of tubing and/or connectors as would be known to a person having an ordinary level of skill in the art.

In some embodiments, the port 140 may have a diameter (i.e., an inner diameter of the tubular channel) of about 1.25 cm. However, it is contemplated that additional diameters may be used for the port to permit interaction with the interior chamber 125 as described. For example, the diameter of the port 140 may be about 10 mm, about 12 mm, about 13 mm, about 14 mm, about 15 mm, about 16 mm, about 17 mm, about 18 mm, about 19 mm, about 1 cm, about 2 cm, about 3 cm, greater than about 3 cm, or individual values or ranges therebetween.

In some embodiments, the port 140 extends through the upper surface 110 and fluidly communicates with the interior chamber 125 and may be arranged some distance from the sidewall 120. In some embodiments, the port 140 is positioned about 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, or greater than 30 mm, or individual values or ranges therebetween. For example, the port 140 may be arranged about 1.0 cm from the sidewall 120 and/or the perimeter of the interior chamber 125. However, this value may be adjusted in a manner such that the port does not inhibit laminar flow through the interior chamber 125 as would be understood by a person having an ordinary level of skill in the art.

In some embodiments, the tubular channel forming the port 140 may have a thickness of about 10 mm. For example, where the port 140 has diameter of about 10 mm, the tubular channel may have an outer diameter of about 14 mm. Accordingly, the port 140 may be configured to receive a “00” rubber stopper therein. However, additional thicknesses as described for the housing 105 are also contemplated herein for the port 140.

In some embodiments, the port 140 may have a diameter (i.e., an inner diameter of the tubular channel) of about 10 mm. However, it is contemplated that additional diameters may be used for the port 140 to permit coupling of a range of rubber stopper sizes, to facilitate access in and out of the interior chamber 125 as described. For example, the diameter of the port 140 may be about 10 mm, about 12 mm, about 13 mm, about 14 mm, about 15 mm, about 16 mm, about 17 mm, about 18 mm, about 19 mm, about 1 cm, about 2 cm, about 3 cm, about 4 cm, about 5 cm, about 10 cm, greater than 10 cm, or individual values or ranges therebetween. The port 140 may be configured to receive rubber stoppers of standard sizes. For example, the port 140 may be coupled with rubber stopper sizes 000, 00, 0, 1, 2, 3, 4, 5, 5.5, 6, 6.5, 7, 7.5, 8, 8.5, 9, 9.5, 10, 10.5, 11, 11.5, 12, 13, 14, 15, 16. In some embodiments, the stopper may not be rubber, and may be comprised of other suitable materials as would be known to a person having an ordinary level of skill in the art.

In an embodiment, the interior chamber 125 may have a diameter of about 6.8 cm and a height of about 1.3 cm. The inlet 130 and the outlet 135 may be diametrically opposed with respect to the interior chamber 125 and may each have a height of about 1 cm above the upper surface 110. The inlet 130 may have a diameter of about 0.4 cm and may be positioned about 0.3 cm from the perimeter of the interior chamber 125. The outlet 135 may have a diameter of about 0.7 cm and may be positioned about 0.55 cm from the perimeter of the interior chamber 125 directly opposite the inlet 130. Accordingly, a center-to-center distance between the inlet 130 and the outlet 135 may be about 5.4 cm. Based on the cylindrical geometry and the dimensions as described, the collection device 100 may achieve a consistently reproducible (i.e., substantially laminar) flow through the interior chamber 125 as further described herein.

Referring now to FIG. 1D, the inlet 130 and/or the outlet 135 may each include a cap 145 selectively coupled thereto. For example, the cap 145 may include threads, snap-fit features, or other mating features configured to mate with the mating features of the inlet 130 and/or the outlet 135 to secure the cap 145 thereto. In some embodiments, the cap 145 comprises openings to permit gas transfer between the external environment and interior chamber. Accordingly, the collection device 100 facilitates equivalent growth conditions for a biological sample therein (e.g., a cell culture) as would be present in a standard incubator. As such, the collection device 100 provides flexibility for the conditions of growth for an organism in the collection device 100 based on the requirements of a study. Accordingly, the collection device 100 may be advantageous when performing studies with specialized microorganism models, e.g., obligate anaerobes, facultative anaerobes, and/or microaerophiles. In additional embodiments, the inlet 130 and/or the outlet 135 may be sealed to protect and/or isolate the biological sample during transport and/or when the collection device 100 is not attached to a fluid flow system as described. In some embodiments, the cap 145 may be removed to attach components of the fluid flow system, e.g., tubing, to the inlet 130 and/or the outlet 135, during VOC collection as described herein.

In some embodiments, the cap 145 may be configured as a connector for direct attachment of tubing and/or connectors of mating components. For example, the cap 145 may be configured to receive a tubing connector thereon and to allow fluid flow through the cap 145 and through the inlet 130 and/or the outlet 135.

In some embodiments, the cap 145 may allow two-way flow of fluids therethrough. In some embodiments, the cap 145 includes a one-way valve or check valve to selectively permit fluid therethrough. For example, the cap 145 on the inlet 130 may include a one-way valve that prohibits fluid flow out of the inlet 130. The one-way valve may also permit fluid flow into the inlet 130 when a pressure is applied on an exterior side of the one-way valve above a threshold pressure and may prohibit fluid flow into the inlet 130 when the pressure is below the threshold pressure. In another example, the cap 145 on the outlet 135 may include a one-way valve that prohibits fluid flow into the outlet 135. The one-way valve may also permit fluid flow out of the outlet 135 when a pressure is applied on an interior side of the one-way valve above a threshold pressure and may prohibit fluid flow out of the outlet 135 when the pressure is below the threshold pressure. In some embodiments, the threshold pressure for each of the inlet 130 and the outlet 135 may be the same. In some embodiments, valves may be integrated directly into the inlet 130 and/or the outlet 135.

The collection device 100 may be designed and configured to promote reproducibility in the sampling of gases from the interior chamber 125 across multiple experiments and/or multiple laboratories. Reproducibility may be promoted by the geometry of the interior chamber 125, which enables consistent flow of fluids (e.g., laminar flow) through the interior chamber 125 and by enables consistent construction of the collection device 100 (e.g., low likelihood of manufacturing defects or error).

In one embodiment, device 100 may further comprise one or more needles, wherein the needle is configured to fit inside at least one port 140 and go through at least one opening. In one embodiment, port 140 may comprise one or more resealable membranes and/or injection ports and is configured to create a seal between chamber 125 and the environment. A needle or syringe may be positioned within chamber 125 and is configured to allow a user to extract media, cells, or any other component without disrupting the environment (sampling). In one embodiment, a needle, syringe or other tool may also be used for medium sampling, medium replacement, injections of drug/compound dosing, physiologic and set-point monitoring, quality assurance data collection, perfusion, insertion of measuring probes, etc. In one embodiment, one or more needles or syringes may be replaced with any other structure including but not limited to a tubing, to allow fluid transportation to or from chamber 125 through port 140 without disrupting the environment.

In some embodiments, the collection device 100, including the interior chamber 125, the inlet 130, and the outlet 135, may be arranged and configured to pass fluid in a substantially laminar flow path through the inlet 130, across the interior chamber 125, and out of the outlet 135. In some embodiments, the rounded and symmetrical geometry of the collection device 100 facilitates laminar flow through the collection device 100. Laminar flow may comprise substantially smooth flow paths of fluid particles in adjacent layers, wherein each layer moves smoothly past the adjacent layers with minimal mixing. In some embodiments, the laminar flow is substantially free of mixing, cross-currents, swirls, and/or eddies. Furthermore, the laminar flow through the collection device 100 is free of stagnant pockets or regions of air such that substantially all of the fluid in the collection device 100 flows through the collections device 100 at a substantially consistent flow rate. Accordingly, the flow paths through the collection device 100 may allow for extraction of substantially all of the air in the interior chamber as further described herein. Additionally, the flow paths through the collection device are predictable and reproducible across various experiments and/or across multiple laboratories to provide consistency in the experimental conditions.

As shown in FIGS. 1A-1H, the substantially cylindrical geometry of the interior chamber 125 of the collection device 100 may facilitate substantially laminar flow therethrough. Vertices, i.e., corner or angles, in the horizontal cross-section of the interior chamber 125 may impede the laminar flow and reduce the reproducibility of the headspace sampling as further described herein. For example, a rectangular chamber forming 90 degree angles and/or other geometries having corners or angles may create turbulence in the flow and/or pockets of stagnant air within the interior chamber 125, which would compromise the laminar flow. Accordingly, the curved cross-section of interior chamber 125 promotes substantially laminar flow. The laminar flow is further described in Examples 1-3 herein.

Furthermore, the collection device 100 may be arranged and configured to simplify manufacturing and thus reduce the potential for manufacturing defects or errors. In some embodiments, the cylindrical geometry of the collection device 100 and/or the interior chamber 125 facilitates relatively simple construction and manufacturing. Curved geometries with greater complexity, e.g., a teardrop shaped chamber, may be more difficult to produce with a high degree of consistency.

In some embodiments, the housing 105 is configured to receive a biological sample within the interior chamber 125. For example, a cell sample may be placed within the interior chamber 125 and maintained, cultured, grown, and/or tested. In some embodiments, a biological sample may be received and/or maintained on a lower surface of the interior chamber 125. In some embodiments, cell media or other cell culturing materials may be received in the interior chamber 125. It should be understood that a ratio between liquid and headspace in the interior chamber may affect detection of VOCs.

In some embodiments, the housing 105 may be constructed in separable parts to facilitate access to the interior chamber. For example, the housing 105 may be constructed as an upper shell and a lower shell may be separated to access the interior chamber 125 and mated to enclose the interior chamber 125, i.e., in the manner of a petri dish. In some embodiments, the upper shell and the lower shell may be mated by friction fit and/or complementary mating components as would be known to a person having an ordinary level of skill in the art. The separable parts of the housing 105 may also facilitate washing and/or sterilization. In some embodiments, the housing 105 may be formed as a unitary body and access to the interior chamber 125 may be achieved by other means. For example, biological samples and other materials may be inserted through the inlet 130 and/or the outlet 135.

In some embodiments, the housing 105 is formed from an optically clear material, e.g., a substantially transparent and/or translucent material. The transparent material may transmit light therethrough to facilitate additional testing and/or observations of a biological sample in the interior chamber 125 through the housing 105. For example, fluorescence assays, microscopy, additional light-based testing and/or additional types of imaging may be performed through the housing 105. In some embodiments, at least one of the upper surface 110, the lower surface 115, and the sidewall 120 are transparent. In some embodiments, the entire housing 105 is transparent. It should be understood that the compatibility of the housing 105 may also be dependent on the diameter of the housing 105. For example, a housing 105 with a relatively small diameter may have a small working field of view, especially accounting for distortions due to the inlet 130 and the outlet 135. Thus, the dimensions of the housing 105 and/or interior chamber 125 as discussed herein may be selected to promote the imaging capabilities through the housing 105.

In some embodiments, the housing 105 may be configured for sterilization and/or autoclave to facilitate repeated use. A material that can withstand the conditions of autoclave will extend the life of the collection device 100, thereby reducing material costs to users.

In some embodiments, the housing 105 may be heat-treated to reduce background VOC production or emission. For example, while plastics and/or polymers may emit VOCs that may interfere with the VOC analysis of a biological sample, the material of the housing may be heat-treated to reduce or eliminate background VOC release by the housing 105. In some embodiments, the housing 105 is heated to a temperature of about 100° C. for at least about 12 hours. Thereafter, a vacuum (e.g., a negative pressure of at least about 25 inHg) is applied to the interior chamber 125 to remove contaminant VOCs that have been released during heating. This process may similarly be performed on additional components to be used with the collection device 100 as further described herein (e.g., PTFE tubing, rubber stoppers, metal nuts and other connectors). However, it should be understood that the heat treatment conditions may be varied to produce adequate VOC removal as would be apparent to a person having an ordinary level of skill in the art. In some embodiments, the components may be heated to a temperature greater than about 100° C. In some embodiments, the heat treatment may be performed for greater than about 12 hours. In some embodiments, the vacuum removal may be performed with a negative pressure greater than about 25 inHg. In additional embodiments, autoclaving may be used to partially reduce background VOC emission. Additional manners of reducing background VOC emission are also contemplated, e.g., surface treatment, ultrasonication, and the like.

In some embodiments, the housing 105 may exhibit substantially consistent cell adhesion. Accordingly, repeated experiments in the housing 105 across the life of the collection device 100 may not require surface treatment in order to maintain adequate cell adhesion properties. For example, treatment with adhesion proteins and/or an acid/base wash may not be required for the housing 105 because such treatments do not significantly affect the cell adhesion properties. Accordingly, the overall costs and time for performing experiments with the collection device 100 may be reduced without sacrificing consistency in the condition of the cell adhesion surface. The cell adhesion properties are further described in Example 9 herein.

While the housing 105 may be formed from a variety of materials, in some embodiments, the housing 105 is formed from glass, e.g., borosilicate glass. Borosilicate glass may be advantageous because it is optically clear, autoclavable, may be heat treated to reduce VOC emission, and may exhibit consistent cell adhesion properties as described above. However, it should be understood that other materials having one or more of these properties may be utilized herein to form the housing 105 as would be apparent to a person having an ordinary level of skill in the art.

In some embodiments, the housing 105 may be produced by glass blowing. However, additional techniques for production of the housing 105 may be utilized as would be known to a person having an ordinary level of skill in the art. The method of production may be dependent on the selected material(s) for the housing 105.

In one embodiment, housing 105 may be made from any material used or described for use in cell culture devices. In one embodiment, housing 105 made be made from a material including but not limited to: glass, Polycarbonate (PC), polypropylene (PP), polyester (PE), polystyrene (PS), acrylonitrile butadiene styrene (ABS), Polylactic acid (PLA), and biocompatible resins for stereolithography. In one embodiment, housing 105 is disposable. In on embodiment, housing 105 may be made from a material that can be sterilized between each use.

The walls of the housing 105 may be formed with a variety of thicknesses. In some embodiments, the upper surface 110, the lower surface 115, and/or the sidewall 120 have a thickness of about 1 mm. Accordingly, where the interior chamber has a diameter of about 6.8 cm and a height of about 1.3 cm, the housing 105 may have an exterior diameter of about 7 cm and an exterior height of about 1.5 cm. However, additional thickness may be used herein, e.g., about 0.5 mm, about 1 mm, about 1.5 mm, about 2 mm, greater than about 2 mm, or individual values or ranges therebetween. In some embodiments, the upper surface 110, the lower surface 115, and/or the sidewall 120 may be constructed with different thicknesses. Reduced thicknesses may be advantageous for reducing material costs and reducing any optical distortion during imaging.

### Fluid Flow System for Collection of Volatile Organic Compounds

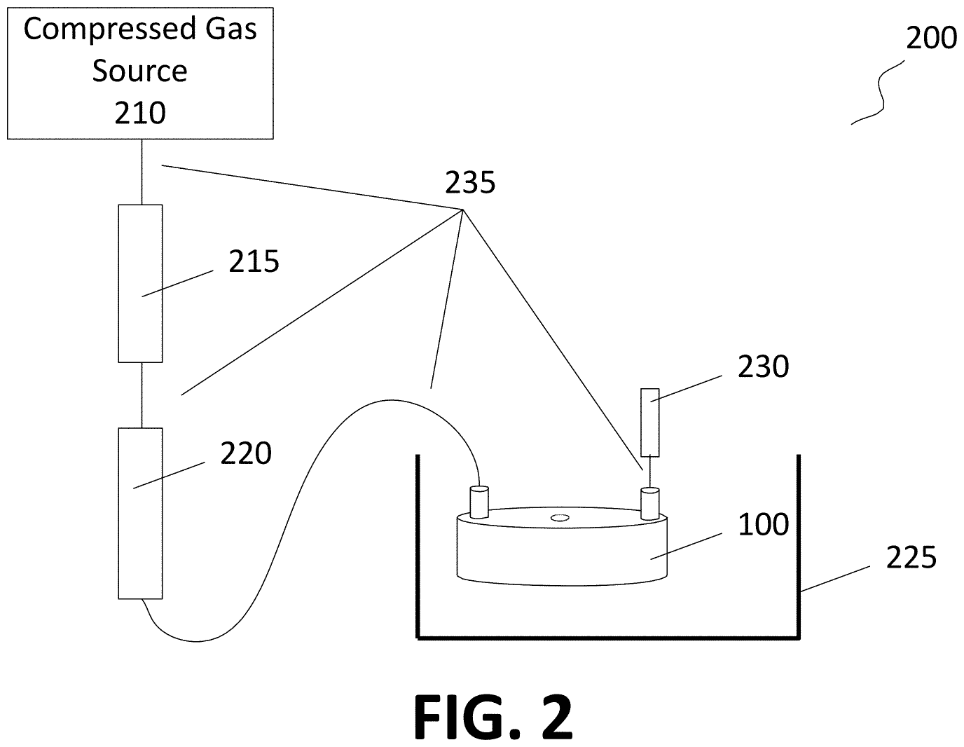

Referring now to FIG. 2, a fluid flow system for collecting VOCs is depicted in accordance with an embodiment. The fluid flow system 200 may be a purge-and-trap system configured for dynamic headspace sampling, whereby fluid may be passed through a sorbent material to capture the VOCs. As shown, the fluid flow system 200 comprises a collection device 100 a compressed gas source 210, a hydrocarbon trap 215, a fluid flow meter 220, a bath 225, and a thermal desorption tube 230 or SPME fibers. The components described herein may be connected to one another by tubing 235 to fluidly communicate therebetween.

In some embodiments, the device 100 may be the collection device according to any of the embodiments described herein, e.g., collection device 100 of FIGS. 1A-1H. Accordingly, the collection device 100 may comprise any of the features and/or characteristics as described with respect to the collection device 100 of FIGS. 1A-1H. One or more biological samples may be received within the collection device 100. For example, living cells (e.g., SKOV-3 cancer cells), bacteria, fungi, archaea, and the like may be received in the collection device 100. Cell media and/or additional components for culturing the biological sample may also be received within the collection device.

In some embodiments, the compressed gas source 210 comprises a compressed gas tank. For example, the gas tank may comprise a fluid mixture containing 5% carbon dioxide (CO₂) and 95% air, which may comprise a mixture of gases present in an ambient or atmospheric environment and in a proportion substantially consistent with ambient or atmospheric conditions. In some embodiments, the 95% air may include nitrogen, oxygen, argon, and/or other components commonly found in the ambient air or atmosphere. This gas mixture may promote growth of mammalian cell cultures. However, the compressed gas source 210 may comprise various mixtures of gas to promote growth, culture and/or proliferation of different types of cells (e.g., mammalian cells, tumor cells, and/or bacterial, fungal, and/or archaeal microorganisms) and/or to meet different modeling conditions (e.g., hypoxia, hyperoxia, etc.). In some embodiments the gas mixture may comprise, but is not limited to, air, hydrogen, nitrogen, carbon dioxide and oxygen in various combinations and concentrations as would be known by someone having an ordinary level of skill in the art. For example, the gas mixture may be an anerobic gas mix comprising about 5% H2, about 20% CO2, and about 75% N2. In another example, the gas mixture may be an aerobic gas mix comprising about 5% CO2 and about 95% air. In another example, the gas mixture may be a hypoxic gas mixture comprising a range of about 1-5% O2, about 5% CO2 and an amount of N2 to balance the mixture. In another example, the gas mixture may be a hyperoxia gas mixture comprising about 95% O2, and about 5% CO2.

In some embodiments, the hydrocarbon trap 215 may be configured to remove hydrocarbon impurities from fluids passing therethrough. For example, the hydrocarbon trap 215 may remove particulates and other contaminants from passing downstream and entering the collection device 100.

In some embodiments, the fluid flow meter 220 may be configured to regulate fluid flow from the compressed fluid source 210 through the system 200. In some embodiments, the fluid flow meter 220 may be configured to maintain a consistent flow rate. In some embodiments, the fluid flow meter 220 may maintain a flow rate of about 11.7 mL/min. In additional embodiments, the flow rate may be about 1 mL/min, about 2 mL/min, about 3 mL/min, about 4 mL/min, about 5 mL/min, about 10 mL/min, about 20 mL/min, about 30 mL/min, 50 mL/min, 100 mL/min, greater than about 100 mL/min, or individual values or ranges therebetween based on the particular application. In some embodiments, the flow rate may be regulated to maintain laminar flow through the collection device 100. Flow rates that permit laminar flow are discussed in further detail in Example 2 herein.

In some embodiments, the bath 225 may be configured to maintain a consistent temperature in the collection device 100 for the biological sample and for VOC collection. As shown in FIG. 2, the collection device 100 may be placed in bath 225. The bath 225 may be filled with a medium to exchange heat with the collection device 100 to maintain the temperature in the collection device 100. In some embodiments, the bath 225 is a bead bath. However, a liquid medium or other types of baths may be utilized as would be apparent to a person having an ordinary level of skill in the art. In some embodiments, the bath 225 is configured to maintain the environment in the collection device 100 at about 37° C. However, additional or alternative temperatures may be maintained based on the particular application. In additional embodiments, the bath 225 may be configured to maintain the environment in the collection device 100 at a range between 0-110° C. For example, the bath 225 may be configured to maintain the environment in the collection device 100 at a range of about 50-55° C. appropriate for thermophile (Thermus aquaticus) growth. In another example the bath 225 may be configured to maintain the environment in the collection device 100 at a range of about 80-110° C. appropriate for Hyperthermophile (Pyrobolus and Pyrodictium archaea) growth. In an additional example the bath 225 may be configured to maintain the environment in the collection device 100 at a range of about <0-4° C. appropriate for psychrophile (Psychrobacter cryohalolentis) growth.

In some embodiments, a semi-rigid sheet of material may be placed within the bath 225 in order to provide a level base for resting the collection device 100. Where the collection device 100 is tilted within the bead bath 225, the culture media may pool on one side of the collection device 100. As such, an opposing side of the collection device 100 may lack moisture and may result in cell death. Accordingly, the rigid sheet may be placed within the media (i.e., beads) of the bath 225 and may be placed substantially level (e.g., by measuring and adjusting with a bubble leveler) to ensure a level resting surface for the collection device 100. In some embodiments, the rigid sheet is a copper sheet (e.g., about 0.125 inches thick), which may be advantageous due to the ideal heat conductivity properties associated with copper.

In some embodiments, the thermal desorption tube 230 comprises a thermal desorption tube. The thermal desorption tube 230 may be used to collect volatile and/or semi-volatile compounds by capturing the compounds in a sorbent within the thermal desorption tube 230. In some embodiments, the thermal desorption tube 230 may be packed with one or more commercially available sorbent packs. For example, the thermal desorption tube 230 may be packed with Carbopack C, Carbopack B, and/or Carbosieve S-III available from MilliporeSigma (formerly known as Sigma-Aldrich) of Munich, Germany. However, various types of sorbents from a variety of commercial providers may be utilized herein based on the particular application and the size of volatiles to be collected. In some embodiments, the thermal desorption tubes 230 may be configured to collect and hold a predetermined amount of air, e.g., about 2 L. However, the loading volume of the thermal desorption tubes 230 may vary based on the particular application. In some embodiments, the thermal desorption tubes may have a loading volume of about 1 L, about 2 L, about 3 L, about 4 L, greater than about 4 L, or individual values or ranges therebetween. thermal desorption tubes 230 of varying sizes may be utilized as would be apparent to a person having an ordinary level of skill in the art.

In certain embodiments, the system comprises SPME fibers in fluid communication with chamber 125 and/or outlet 135, where the SPME fibers are used to collect volatile and/or semi volatile compounds produced by device 100. In some embodiments, the SPME fibers are in fluid communication with outlet 135 and interior chamber 125, with the SPME fibers configured to collect the displaced volume of headspace from the interior chamber 125 and capture VOCs from the displaced headspace.

The various components of the system 200 may be connected by tubing 235, e.g., PTFE tubing. In some embodiments, the PTFE tubing may be joined to the components of the system 200 by connectors, nuts, or adapters to hermetically seal the system 200 from the exterior environment. In some embodiments, tape or another sealing component may be used to reinforce the hermetic seal between the tubing 235 and the various components and/or to prevent leaking at the junctions. For example, Teflon tape may be used to reinforce the junctions between the tubing 235 and the other components of the system 200.

The system 200 may include additional components to facilitate consistent experimental conditions. In some embodiments, sterile filters may be included along the fluid pathway and/or at junctions between components to remove additional impurities in the system 200 and prevent the travel of impurities downstream to the collection device 100 and/or the thermal desorption tube 230. The sterile filters may also reduce turbulent kinetic energy of inert gas from the compressed gas source 210. Accordingly, by reducing turbulent flow received from the fluid flow meter 220, laminar flow through the collection device 100 is promoted. In some embodiments, rubber stoppers may be used to seal components at various points during an experimental procedure. For example, a thermal desorption tube 230 may be coupled to an outlet of the collection device 100 by a rubber stopper in order to form a hermetic seal therebetween such that headspace gas passes through the thermal desorption tube 230 before venting to the exterior environment. Thus, the likelihood of headspace gas escaping from the junction between the outlet and the thermal desorption tube is reduced.

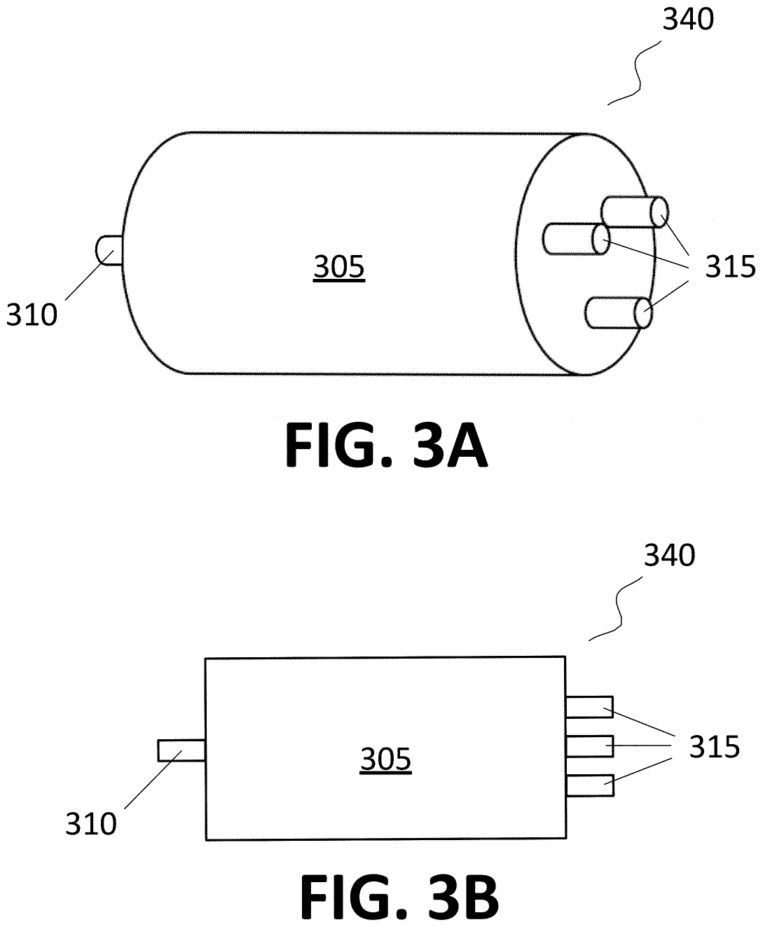

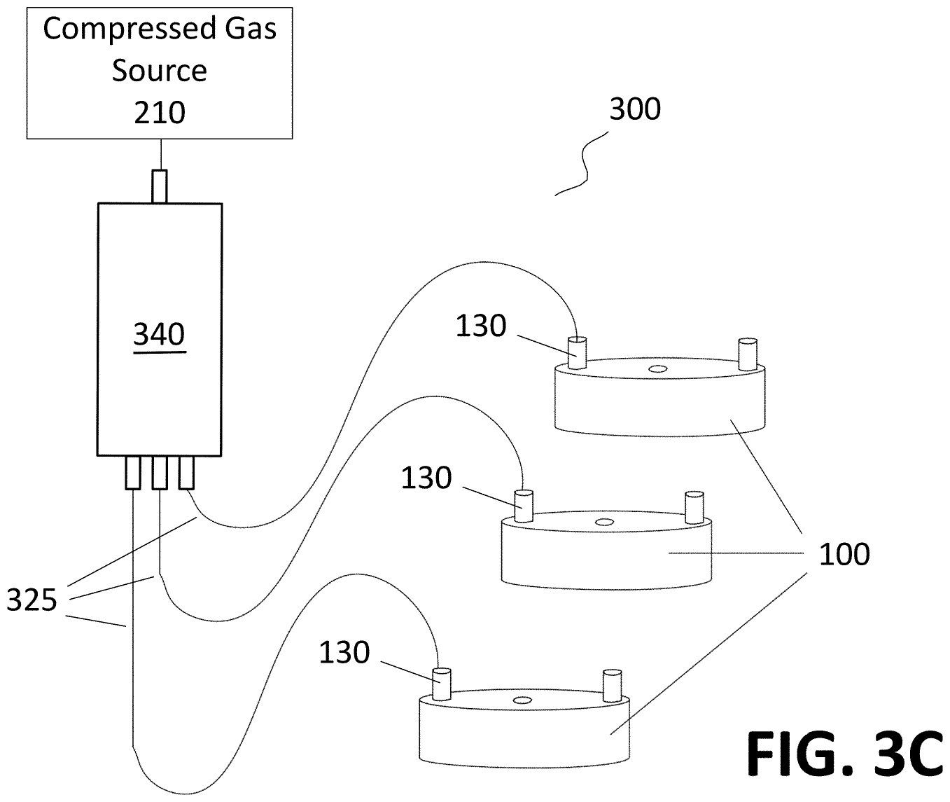

The present invention also comprises a part that enables multiplexing of more than one system 100 connected to a gas source 210 for conducting simultaneous experiments. The multiplexing is enabled using a manifold style part that splits the flow of gas from one inlet of the manifold body to one or more outlets of the manifold body. Referring now to FIG. 3A-3B, a multiplexing part 340 for splitting the air flow of the compressed gas source 210 to more than one collection device 100 is depicted in accordance with an embodiment.

Referring now to FIG. 3C, a multiplexing fluid flow system 300 for conducting parallel experimentation with one or more collection devices 100 as depicted in accordance with an embodiment. The multiplexing fluid flow system 300 may be comprised of a manifold-type multiplexing part 340 configured to distribute compressed gas to more than one collection device 100. In some embodiments, the multiplexing fluid flow system 300 comprises all the features of the VOC detection system 200 as previously described.

In some embodiments, the multiplexing part 340 may be configured to distribute fluid flow from the compressed gas source 210 to a plurality of collection devices 100 in parallel. In some embodiments, the multiplexing part 340 may be configured to distribute fluid flow from the compressed gas source 210 to a plurality of systems 200 arranged in parallel. In some embodiments, the multiplexing part 340 may maintain a flow rate of about 11.7 mL/min. In additional embodiments, the flow rate may be about 1 mL/min, about 2 mL/min, about 3 mL/min, about 4 mL/min, about 5 mL/min, about 10 mL/min, about 20 mL/min, about 30 mL/min, 50 mL/min, 100 mL/min, greater than about 100 mL/min, or individual values or ranges therebetween based on the particular application. In some embodiments, the flow rate may be regulated to maintain laminar flow through a plurality of collection devices 100. Flow rates that permit laminar flow are discussed in further detail in Example 5 herein.

The various components of system 300 may be connected by tubing 325, e.g., PTFE tubing. In some embodiments, the PTFE tubing may be joined to the components of the system 300 by connectors, nuts, or adapters to hermetically seal the system 300 from the exterior environment. In some embodiments, tape or another sealing component may be used to reinforce the hermetic seal between the tubing 325 and the various components and/or to prevent leaking at the junctions. For example, Teflon tape may be used to reinforce the junctions between the tubing 325 and the other components of the system 300.

When the system 300 is assembled in FIG. 3C, the system 200 of FIG. 2 may be combined with system 300 to form an embodiment of the invention. Combining aspects of both systems, the inert gas may be released from compressed gas source 210, pass through the hydrocarbon filter 215, to the fluid flow meter 220 and then into the multiplexing part 340 for distribution to one or more systems 200. In one embodiment, the multiplexing part 340 is used for delivering gas to a plurality of systems 200. In one embodiment, the multiplexing part is used for delivering gas to one system 200, and one or more of the outlets 315 are closed with rubber stoppers or by any suitable method that will stop the flow of gas.

In some embodiments, the multiplexing part 340 is comprised of one inlet 310 and more than one outlet 315 attached on substantially diametrically opposed ends of a manifold body 305. In some embodiments, the multiplexing part 340 is comprised of more than one inlet 310 and more than one outlet 315 attached on substantially diametrically opposed ends of a manifold body 305. In some embodiments, the multiplexing part 340 is comprised of a cylindrical manifold body 305. In some embodiments, the multiplexing part 340 is comprised of a spherical manifold body 305. In some embodiments, the multiplexing part 340 and body 305 is comprised of individual channels for directing the flow of gas. In some embodiments, the multiplexing part 340 and/or body 305 are comprised of features that would be used in the directing of fluid flow as designed by someone having an ordinary level of skill in the art.

In some embodiments, the multiplexing part 340 is configured to withstand autoclaving. In some embodiments, the multiplexing part 340 is heat-treated to reduce background VOC release.

In some embodiments, the multiplexing part 340 is a substantially transparent material configured to transmit light therethrough. In some embodiments, the multiplexing part 340 is a substantially transparent material that may comprise borosilicate glass. However, it should be understood that other materials having one or more of these properties may be utilized herein to form the multiplexing part 340 as would be apparent to a person having an ordinary level of skill in the art.

In some embodiments, the multiplexing part 340 may be produced by glass blowing. However, additional techniques for production of the multiplexing part 340 may be utilized as would be known to a person having an ordinary level of skill in the art. The method of production may be dependent on the selected material(s) for the multiplexing part 340.

The inlet 310 and/or the outlets 315 of multiplexing part 340 may be formed in a variety of shapes and/or sizes to facilitate mating with various types of tubing and/or connectors therewith. In some embodiments, the inlet 310 and/or the outlets 315 may include mating features, e.g., threads, ridges, grooves, and/or the like to allow coupling of tubing and/or connectors as would be known to a person having an ordinary level of skill in the art.

In some embodiments, the inlet 310 may have a diameter (i.e., an inner diameter of the tubular channel) of about 4 mm. However, it is contemplated that additional diameters may be used for the inlet 310 to permit and facilitate substantially laminar flow into and through the manifold body 305 as described. For example, the inner diameter of the inlet 310 may be about 1 mm, about 2 mm, about 3 mm, about 4 mm, about 5 mm, about 6 mm, about 7 mm, about 8 mm, about 9 mm, about 1 cm, about 2 cm, about 3 cm, greater than about 3 cm, or individual values or ranges therebetween.

In some embodiments, the tubular channel forming the inlet 310 may have a thickness of about 1 mm. For example, where the inlet 310 has diameter of about 4 mm, the tubular channel may have an outer diameter of about 6 mm or about 6.35 mm (i.e., about ¼inch). Accordingly, the inlet 310 may be configured to receive ¼ inch tubing thereon. In some embodiments, the inlet 310 may have an outer diameter of about 12.7 mm (½ inch), about 19 mm (¾ in), or about 31 mm ( 5/4 in). However, additional thicknesses as described for the manifold body 305 are also contemplated herein for the inlet 310.

In some embodiments, the outlets 315 may have a diameter (i.e., an inner diameter of the tubular channel) of about 4 mm. However, it is contemplated that additional diameters may be used for the outlets 315 to permit coupling of a rubber stopper, and/or tubing with the outlet 315 and to facilitate substantially laminar flow through and out of the manifold body 305 as described. For example, the diameter of the outlet 315 may be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 10 cm, greater than 10 cm, or individual values or ranges therebetween.

In some embodiments, the tubular channel forming the outlet 315 may have a thickness configured to fit a rubber stopper, tubing, and/or a metal nut assembly thereon. For example, the tubular channel may have a thickness of about 4 mm, the tubular channel may have an outer diameter of about 6 mm or about 6.35 mm (i.e., about ¼ inch). Accordingly, the outlet 315 may be configured to receive a rubber stopper, PTFE tubing, and/or a metal nut assembly thereon to form a seal between the outlet 315 and the inlet 310 of the multiplex part 340. However, additional thicknesses as described for manifold body 305 are also contemplated herein for the outlet 315.

In some embodiments, the manifold body 305 has a wall thickness of about 4 mm. However, additional thickness may be used herein, e.g., about 0.5 mm, about 1 mm, about 1.5 mm, about 2 mm, greater than about 2 mm, or individual values or ranges therebetween. In some embodiments, the wall thickness of manifold body 305 may not be uniform across the part and may be more thick or thin as determined as by someone having an ordinary skill in the art.

Referring now back to FIGS. 2 and 3, the system 200 and system 300 as described herein may be used to collect VOCs from a living biological sample to analyze VOC abundance across time. For example, as described, a biological sample may be loaded and cultured or maintained within the collection device 100. The biological sample may release VOCs into the environment within the collection device 100 (i.e., the headspace). When the system is assembled as shown in FIG. 2, inert gas may be released from the compressed gas source 210, passed through the hydrocarbon filter 215, and to the fluid flow meter 220. The fluid flow meter may regulate the flow of the inert gas to maintain a predetermined flow rate, e.g., about 11.7 mL/min or additional flow rates permitting laminar flow through the collection device 100 as described herein. The inert gas may flow through the fluid flow meter 220 at the predetermined flow rate and into the collection device 100, thereby displacing the headspace within the collection device 100 into the thermal desorption tube 230. The VOCs within the displaced headspace may be captured by the thermal desorption tube 230 and/or SPME fibers. Due to the substantially laminar flow through the collection device 100, substantially all of the headspace within the collection device 100 may be displaced into the thermal desorption tube 230 by an equal volume of inert gas from the compressed gas source 210. Accordingly, a substantial entirety of the headspace within the collection device 100 may be captured by the system 200.

In some embodiments, a predetermined amount of headspace may be loaded into and captured by the thermal desorption tubes 230, e.g., about 2 L. However, varying amounts of headspace may be collected based on the particular application. In some embodiments, the thermal desorption tubes may have a loading volume of about 1 L, 2 L, 3 L, 4 L, 5 L, 6 L, 7 L, 8 L, 9 L, 10 L, 11 L, 12 L, 13 L, 14 L, 15 L, 16 L, 17 L, 18 L, 19 L, 20 L greater than 20 L, or individual values or ranges therebetween. In some embodiments, a plurality of thermal desorption tubes 230 may be utilized to capture a large amount of headspace. For example, the thermal desorption tube 230 may be detached after reaching capacity and may be replaced with another thermal desorption tube 230. In some embodiments, headspace may be collected at discrete spaced intervals. For example, headspace may be collected in separate thermal desorption tubes 230 or SPME fibers according to a schedule, wherein the discrete intervals are minutes, hours, and/or days apart. In embodiments, continuous analysis may be performed by collecting the headspace continuously at a consistent rate over a period of time, e.g., about 6 hours, about 12 hours, about 24 hours, greater than about 24 hours, or individual values or ranges therebetween.

Subsequently, the VOCs may be extracted from the thermal desorption tubes 230 by a thermal desorption unit as would be known to a person having an ordinary level of skill in the art. For example, the VOCs may be extracted from the thermal desorption tubes 230 by the Thermal Desorption Unit (TDU 2) available from Gerstel, Inc. of Linthicum, Md. Additionally, VOCs may be extracted from SPME fibers as would be known to a person having an ordinary level of skill in the art.

The extracted VOCs may be identified through chromatography and/or spectrometry. For example, a two-dimensional gas chromatograph and/or a time-of-flight mass spectrometer may be utilized to assess VOC abundance across time by identifying the presence of VOCs and/or quantifying amounts of particular VOCs in the headspace collected over a period of time. Accordingly, these findings may be used to identify biomarkers and/or trends in the VOC compositions that indicate and/or correlate to specific states or conditions of the biological sample. Analysis of the VOCs is further described in Example 6 herein.

While the system 200 as described is configured for detecting and assessing VOC abundance across several hours or more, it should be understood that the collection devices described herein may be used for monitoring the presence and/or quantity of VOCs from an organism over shorter periods of time with appropriate modifications. In some embodiments, a greater number of thermal desorption tubes may be used to collect store smaller volumes of headspace over shorter periods of time (e.g., less than one hour), thereby providing greater temporal resolution in the acquired measurements. Accordingly, the detected VOCs may reveal patterns in VOC abundance over discrete intervals of time.

In some embodiments, thermal desorption tubes may not be used for collection of headspace. For example, the outlet of the collection device maybe connected directly or via tubing to a gas chromatography-mass spectrometry (GC-MS) instrument to detect, identify, and/or measure VOCs from the headspace continuously with high temporal resolution. In some embodiments, the GC-MS instrument may be configured to provide VOC measurements in real-time. For example, the VOC measurements may be processed in real-time and output to a display device for immediate review by a researcher, clinician, and/or patient.

Detection and analysis of VOCs may have a variety of clinical applications. Generally, abundance of VOCs detected from a biological sample may be a direct measure of active metabolic processes, thus providing a window into organism phenotype. Similarly, VOC byproducts of cellular metabolism can indicate an abnormal health state (e.g., cancer and/or infection). For example, in preclinical stages of cancer, patient tissue biopsy samples may be cultured and VOCs may be analyzed to provide an early diagnostic for a variety of cancers, e.g., skin cancer, lung cancer, renal cancer, prostate cancer, cervical cancer, and other types of cancer for which samples may be minimally invasively and/or non-invasively collected for VOC analysis. In another example, breath samples may be collected and analyzed for VOC abundance in order to assess a patient's lungs for, but not limited to, lung cancer, bacterial infection, viral infection, fungal infection and other ailments of the lungs.

Detection and analysis of VOCs may also have a variety of research applications. Using specific experimental conditions, e.g., compressed gas composition, flow rate, bath temperature, and the like, organisms such as bacteria, fungi, archaea, eukaryotes, and other types of organisms may be studied. Responses to changes in a microenvironment (e.g., oxygen availability, temperature, etc.) may be assessed with regards to effect on VOC production. Because some VOCs act as signaling molecules (e.g., 16-hexadecanol for the beta oxidation pathway), specialized VOC mixtures may also be used as an input to induce desired phenotypes in living organisms. Furthermore, interactions between species or types of microorganisms (e.g., bacteria and fungi) may be driven by exchange of VOCs and may have various effects on environments and ecosystems. Accordingly, understanding the role of VOCs in these interactions will enhance the currently limited understanding of the relationships between microorganisms.

It should be understood that the field of volatile metabolomics is rapidly developing and additional novel applications of VOCs may be discovered. Accordingly, the devices, systems, and methods as described herein may be applied and adapted to a variety of studies and applications within the growing field.

The present invention is not limited to the detection and/or analysis of VOCs and in certain embodiments cells and/or media contained within the device 100 are monitored and/or analyzed using techniques known the art. For example, in certain embodiments, cells and/or media is extracted from device 100 (for example through port 140) which can be analyzed using bulk or single-cell RNA/DNA sequencing, proteomics, and metabolomics. In some embodiments different cell types are co-cultured within a shared environment in device 100 that allows for cell-cell communication and the detection and/or analysis of VOCs. For example, in one embodiment a bacterial-cell coculture is cultured in device 100 for the detection and/or analysis of VOCs.

Cells to be cultured within system 100 may be isolated from a number of sources, including, for example, biopsies from living subjects and whole-organ recovered from cadavers. In one embodiment, the isolated cells are autologous cells obtained by biopsy. The biopsy may be obtained using a biopsy needle, a rapid action needle which makes the procedure quick and simple.

In one embodiment, device 100 may be used for screening-based identification of novel therapeutic targets. In one embodiment, device 100 may be used for discovery and validation of disease biomarkers.

As described above, the optically clear collection device 100 may facilitate additional testing of the biological sample that may provide additional data and/or provide secondary validation of findings. In one embodiment, cells can be monitored from time to time by microscopic inspection through the generally transparent surfaces. Cells can be monitored for growth, differentiation, morphology, health, and the like. In some embodiments, fluorescence assays, e.g., live/dead assays, may be performed on the biological sample within the collection device. In some embodiments, fluorescence-based reporter molecules may be used to perturb the biological sample. The fluorescence may be detected in real-time by microscopy and/or another external system as would be known to a person having an ordinary level of skill in the art. Furthermore, the VOC output may be timestamped and related to the fluorescence data to draw correlations, additional findings, and/or conclusions from the VOC assessment. Assessment through imaging is further described in Example 8 herein.

The cells, cellular components (e.g., proteins, DNA, and RNA), or media obtained from the device can be analyzed using any methodology known in the art. For example, cells can be stained and/or analyzed using immunofluorescence, immunocytochemistry, immunohistochemistry, or the like. In another example, cells can be visualized and analyzed using genetically encoded fluorophores. In certain embodiments, the cells may be lysed to analyze protein expression, RNA expression, etc. Exemplary techniques used to analyze the cells or media obtained from the device includes, but is not limited to, DNA sequencing, RNA sequencing, PCR, RT-PCR, protein sequencing, immunoblotting, immunoprecipitation, ELISA, mass spectrometry, crystallography, and the like. Further, cells obtained from the device can further be subjected to one or more cellular assays to evaluate the function of the obtained cells. As a skilled artisan would readily understand, the present invention is not limited to any particular analysis, technique, or assay; but rather any suitable analysis, technique, or assay may be conducted on cells, media, or cellular components (e.g., proteins, DNA, and RNA) obtained from the device.

In some embodiments, the thermal desorption tubes 230 may be re-usable. In some embodiments, the thermal desorption tubes 230 may be conditioned after collection and analysis of VOCs to effectively purge and clean the thermal desorption tubes 230 for re-use in additional experiments. In some embodiments, the thermal desorption tubes 230 are heated to a temperature of at least about 200° C. and nitrogen gas (N2) is passed through the thermal desorption tube 230 (i.e., through the sorbent packing material therein) for about three hours. In some embodiments, the thermal desorption tubes 230 are cycled through multiple rounds of such treatment, e.g., about 5 cycles. Accordingly, the thermal desorption tubes 230 may be re-used in future experiments.

### Method of Use

In one aspect, the present invention provides a method of using device 100 within system 200 and system 300. It should be noted that any methods that can be used on system 200 are considered relevant and applicable to system 300 as described herein. In one embodiment, the method comprises introducing and culturing cells into a device 100, wherein cells are cultured on any form of media as would be known by someone with an ordinary level of skill in the art. In one embodiment, the method comprises connecting a gas source 210 and delivering gas to an inlet 130 on device 100. In one embodiment, the method comprises collecting VOCs from the outlet 135 of the device 100 for analysis. In one embodiment, the method comprises connecting a thermal desorption tube 230 to the outlet 135 for collecting the exhaust gas of device 100. In one embodiment, the method comprises connecting SPME fibers to the outlet 135 for collecting the exhaust gas of device 100. In one embodiment, the method comprises using the at least one port 140 to introduce reagents or remove material (e.g., media and/or cells) from the interior of the chamber 125 of device 100. In one embodiment, the method comprises delivering a gas mixture to inlet 130 suitable for producing an anerobic environment in the interior chamber 125 of device 100. In one embodiment, the method comprises capturing the exhaust gases produced during cell culturing in device 100 and analyzing the exhaust gases for the presence of molecules or compounds that may indicate the presence of certain cells, cell life-cycle stages, cell-death, diseases, VOCs, and/or biomarkers. In some embodiments, the method comprises delivering a drug or therapeutic agent to the cell culture in device 100 via the use of port 140. In some embodiments, the method comprises controlling the temperature of system 200 or system 300 by the use of a heating and/or cooling device.

Although the present invention has been described in considerable detail with reference to certain preferred embodiments thereof, other versions are possible. Therefore, the spirit and scope of the appended claims should not be limited to the description and the preferred versions contained within this specification. Various aspects of the present invention will be illustrated with reference to the following non-limiting examples:

### EXAMPLES

### Example 1—Fluid Modeling within Biodome Under Experimental Conditions

Methods. ANSYS fluid modeling software was used to demonstrate expected flow characteristics of a fluid within the biodome as described herein. The precise geometry and experimental flow conditions were used as inputs to generate the fluid flow model.

### Flow Profile

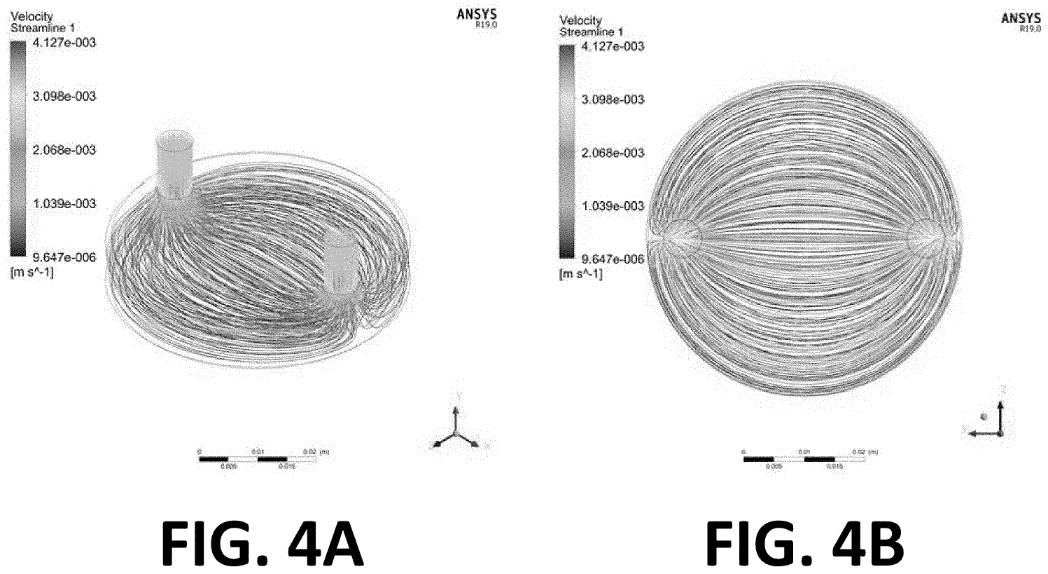

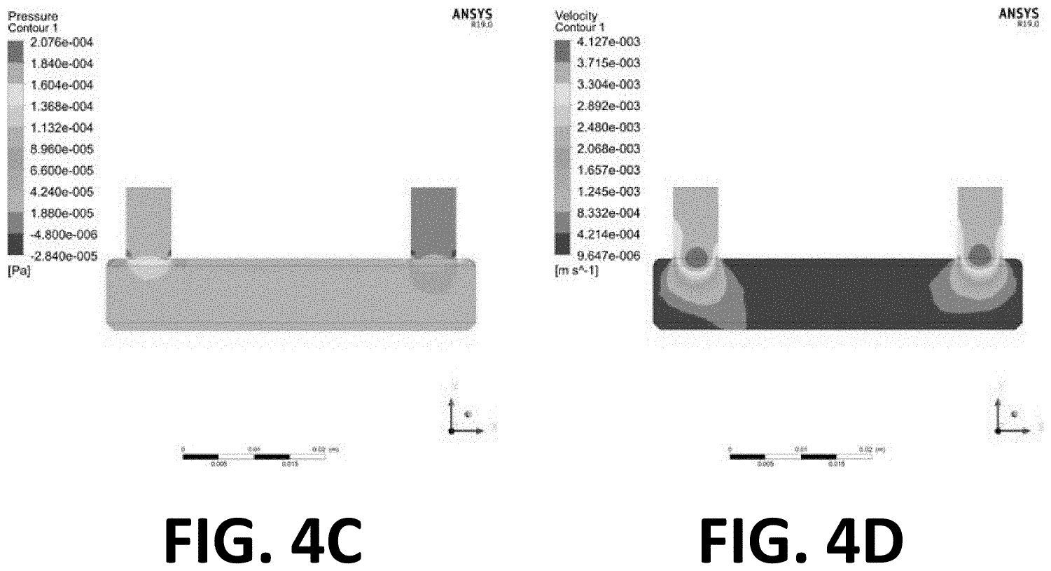

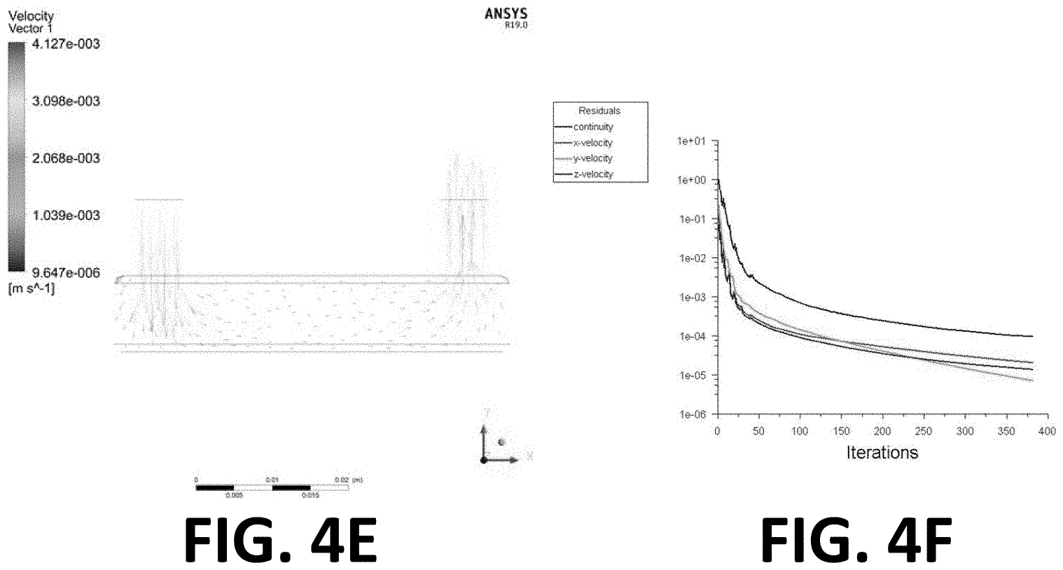

Results. FIGS. 4A-4B depict a side view and top view, respectively, of the fluid (gas) flow profile in the biodome collection device. The fluid is shown to have laminar flow under experimental conditions, which is ideal for improving sampling reproducibility across laboratories.

### Pressure and Velocity Profiles

Results. FIG. 4C depicts the pressure contour profile through the center of the biodome collection device along the X-Y plane. FIG. 4D depicts the velocity contour profile through the center of the biodome collection device along the X-Y plane. FIG. 4E depicts the velocity vector profile through the biodome collection device along the same X-Y plane. FIG. 4F depicts the ANSYS solver residuals for the constructed fluid profiles, minimized across ˜400 iterations.

### Example 2—Flow Profile Modeling with Updated Biodome Geometry with Varying Flow Rates

Methods. ANSYS fluid modeling software was used to demonstrate expected flow characteristics of a fluid within the biodome as described herein. The dimensions of the biodome that were used as inputs to generate this fluid flow model are as follows: biodome diameter of 7 cm; biodome height of about 1.5 cm; inlet diameter of 0.4 cm; inlet distance from perimeter of 0.3 cm; outlet diameter of 0.7 cm; outlet distance from perimeter of 0.55 cm. Turbulent flow models were constructed for 5 different flow rates: 11.7 mL/min, 20 mL/min, 30 mL/min, 40 mL/min, and 50 mL/min. These models were used to determine the maximum flow rate into the Biodome that maintained laminar flow.

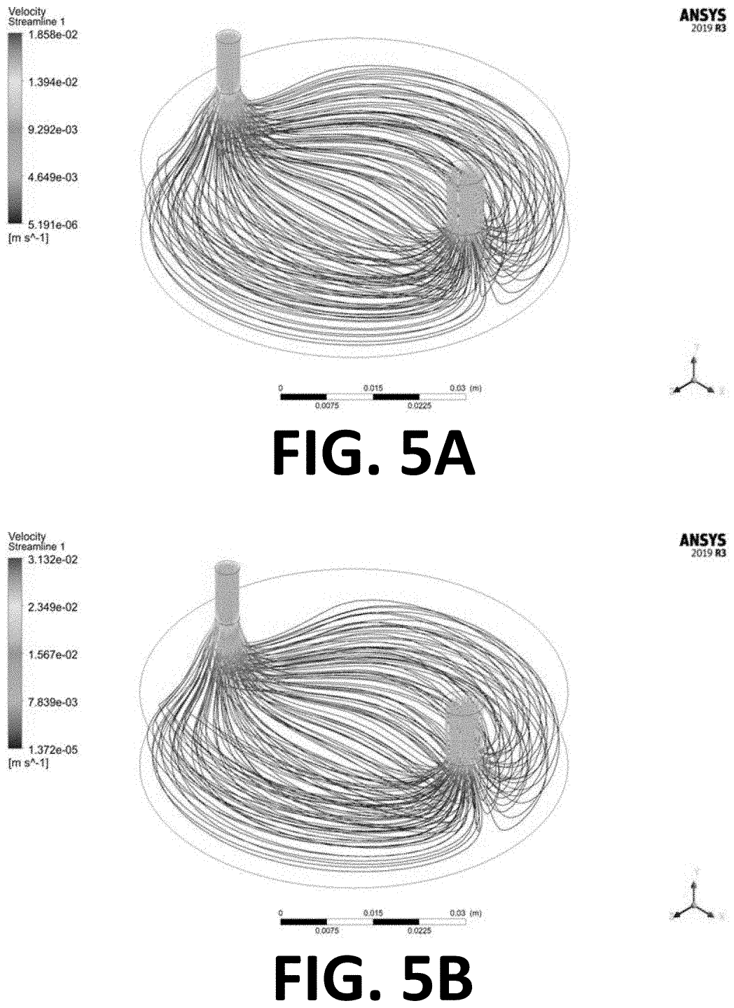

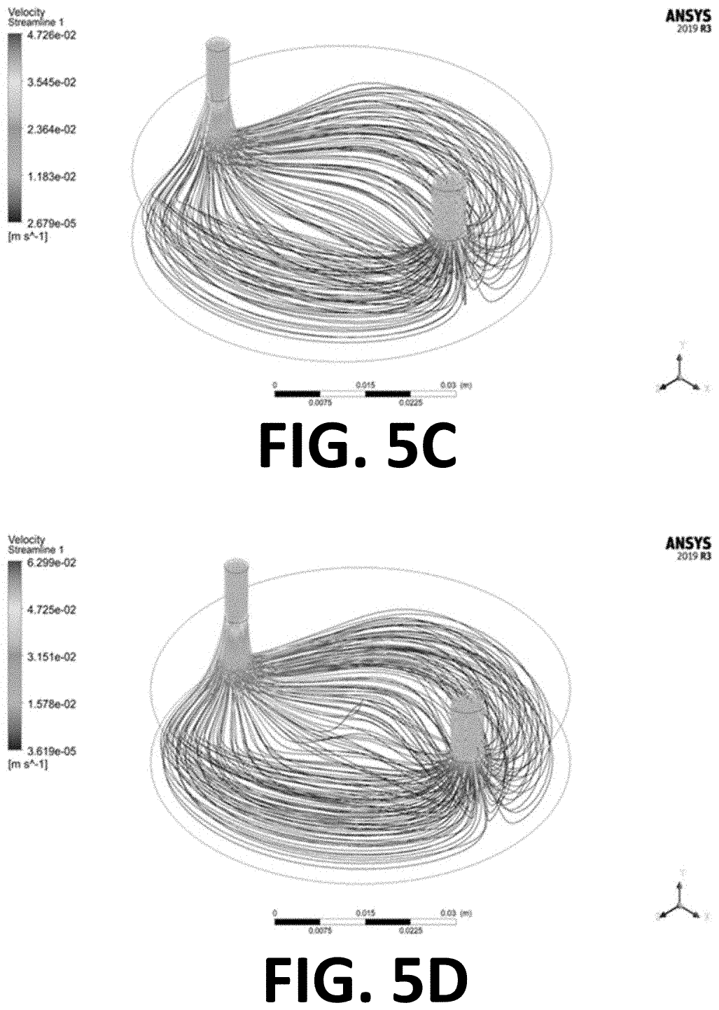

Results. FIGS. 5A-5E depict the fluid (gas) flow profile in the biodome collection device with updated geometry at various flow rates. FIG. 5A depicts the fluid flow profile through the biodome at a flow rate of 11.7 mL/min. FIG. 5B depicts the fluid flow profile through the biodome at a flow rate of 20 mL/min. FIG. 5C depicts the fluid flow profile through the biodome at a flow rate of 30 mL/min. FIG. 5D depicts the fluid flow profile through the biodome at a flow rate of 40 mL/min. FIG. 5E depicts the fluid flow profile through the biodome at a flow rate of 50 mL/min. The fluid is shown to have laminar flow under experimental conditions (FIG. 5A), which is ideal for improving sampling reproducibility across laboratories.

### Example 3—Flow Profile Modeling with Varying Biodome Dimensions

Methods. ANSYS fluid modeling software was used to demonstrate expected flow characteristics of a fluid within the biodome as described herein for varying dimensions and flow rates. Turbulent flow models were constructed for varying biodome heights (0.25 cm, 0.5 cm, 1.5 cm, 2.5 cm, and 3.5 cm), varying diameters (3 cm, 5 cm, 7 cm, 10 cm, and 20 cm), and varying flow rates (1 mL/min, 5 mL/min, 11.7 mL/min, and 30 mL/min). These models were used to determine the maximum dimensions of the Biodome that maintained laminar flow under varying flow rates.

Results. Laminar flow conditions were achieved in modeling for biodomes of heights up to 2.5 cm under experimental flow rates of 11.7 mL/min. Lower flow rates may also yield laminar flow conditions. A height of 3.5 cm appeared to yield turbulent flow for a wide range of flow rates (5-30 mL/min) under these dimensions. Accordingly, biodomes with a large height, i.e., 2.5 cm or greater, may fail to sweep the entire headspace under these dimensions, leaving volumes of stagnant air. However, alternative device specifications such as inlet/outlet diameter, inlet/outlet positioning, and flow rate may not yield turbulent flow. Accordingly, multiple device specifications have been shown to produce laminar flow, which is ideal for improving sampling reproducibility across laboratories.

### Example 4—Fluid Profile Modeling with Varying Configurations of Biodome Inlets/Outlets

Methods. ANSYS fluid modeling software was used to demonstrate expected flow characteristics of a fluid within the biodome as described herein for varying numbers of inlets and outlets. Turbulent flow models were constructed for biodomes with varying numbers of inlets and outlets with a total flow rate of 11.8 mL/min. These models were used to determine desirable configurations of the Biodome that maintained laminar flow under the desired experimental flow rate.

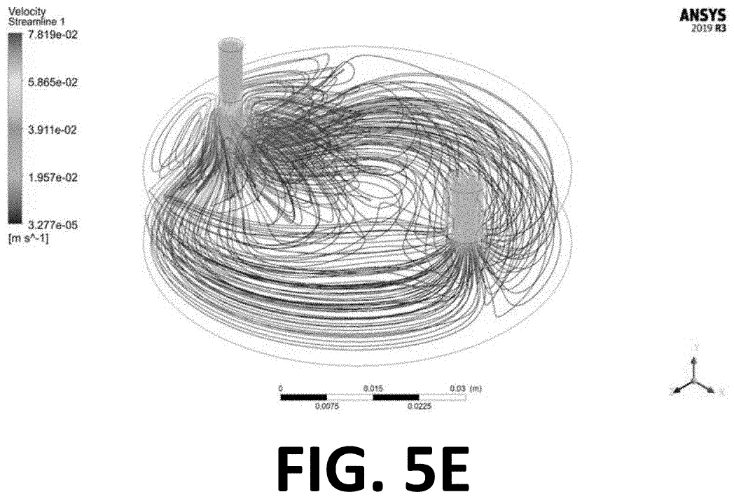

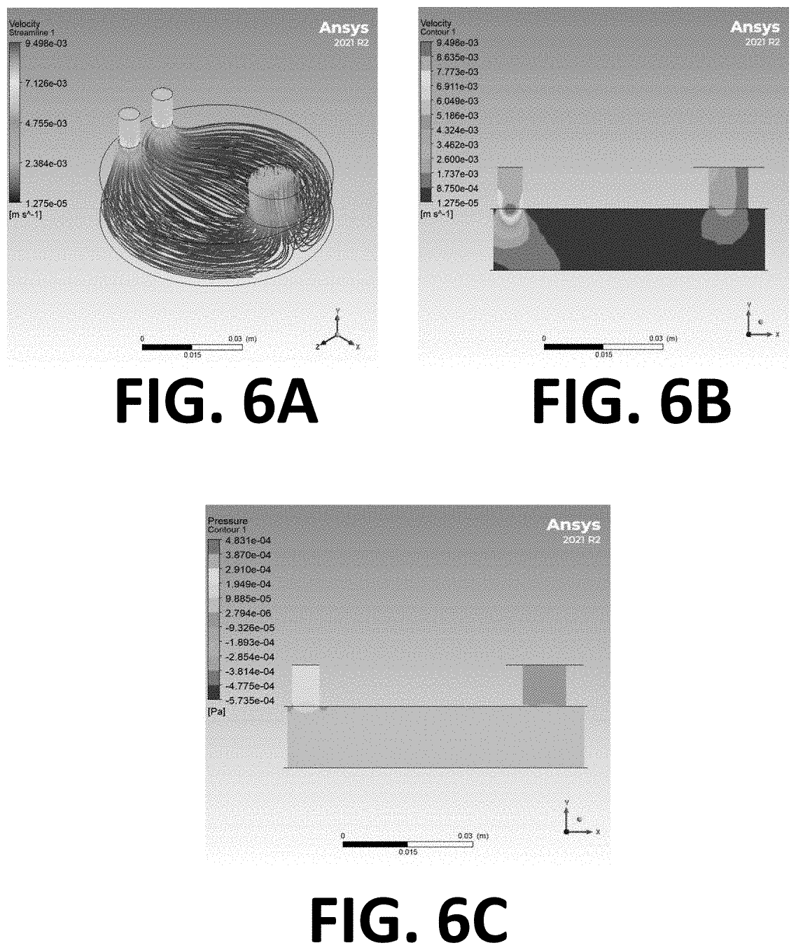

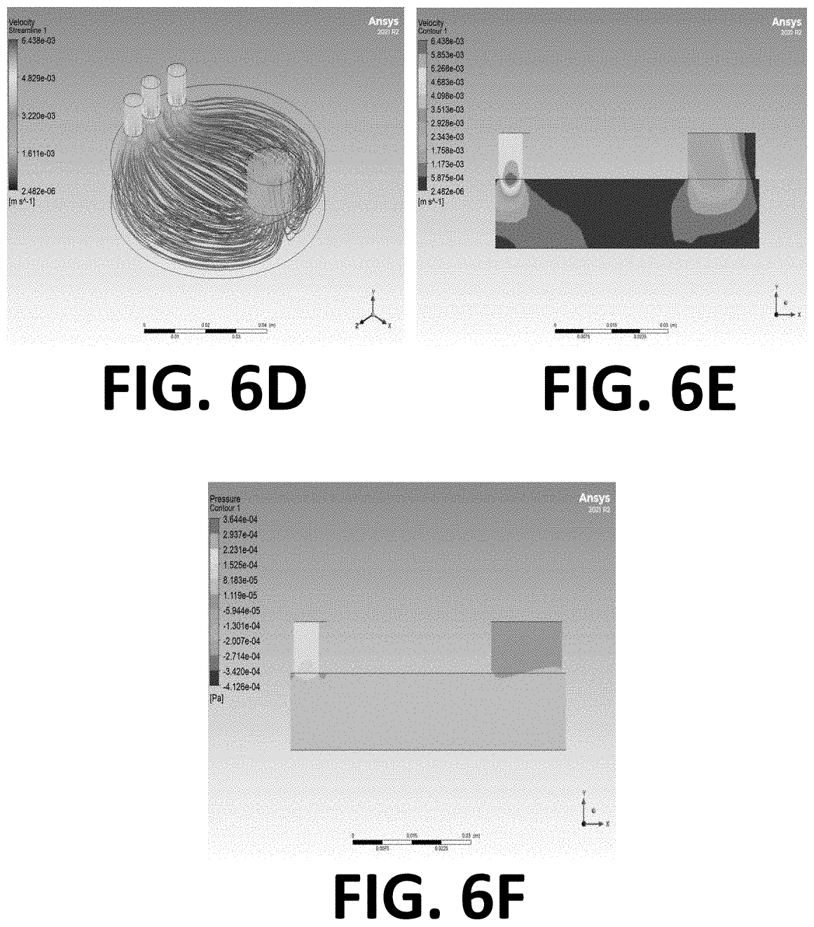

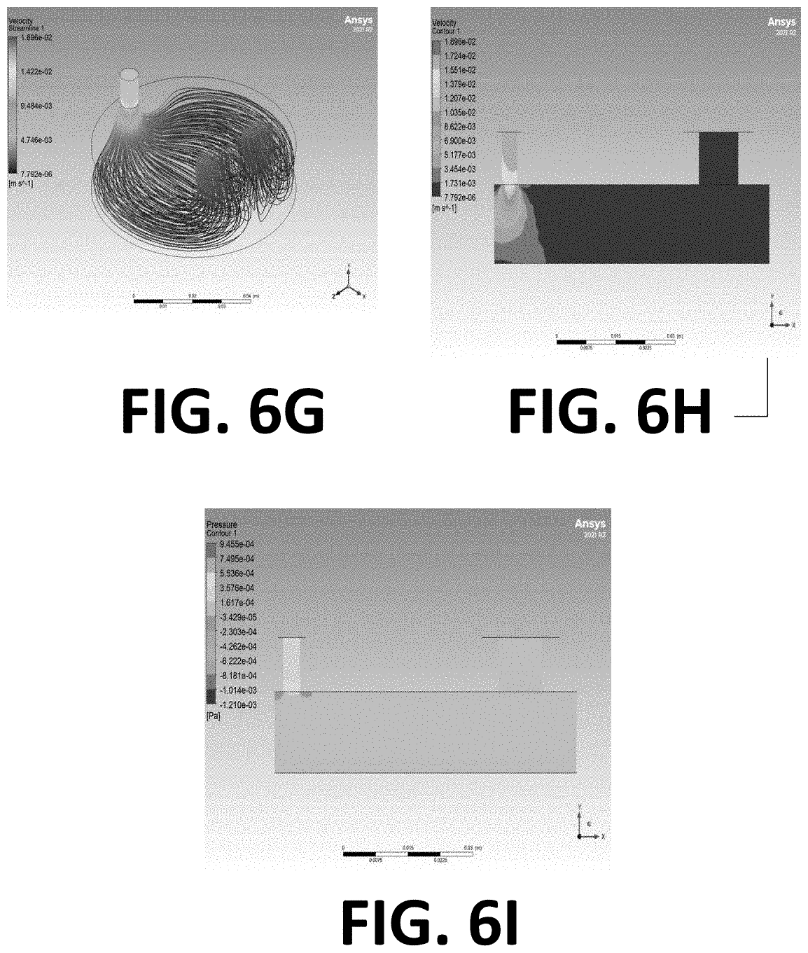

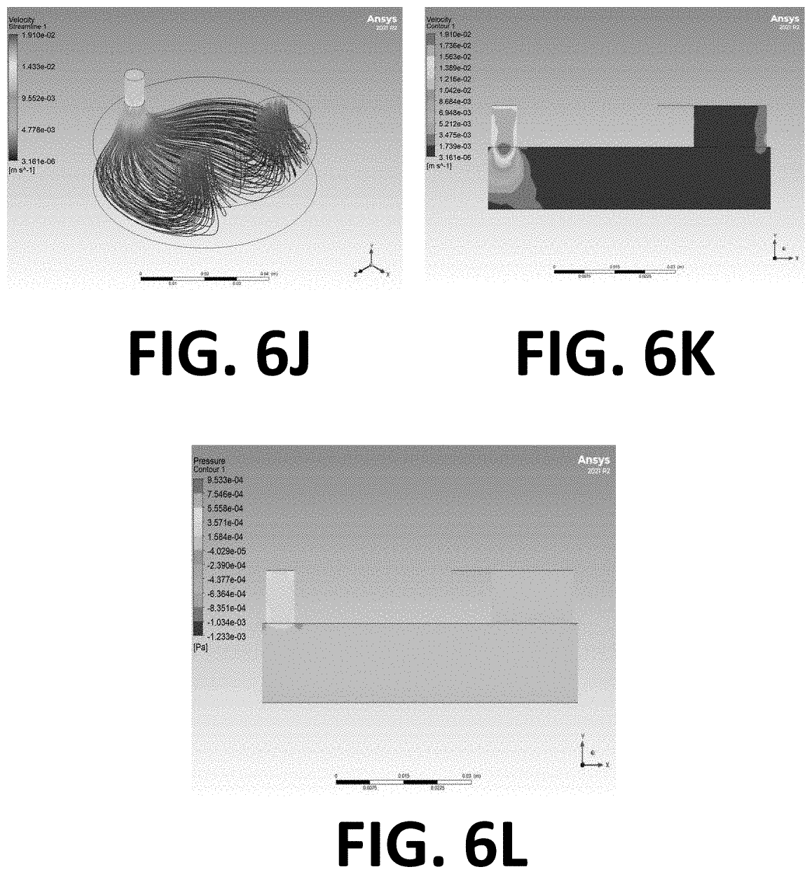

Results. Laminar flow conditions were achieved in modeling for biodomes of various inlet/outlet configurations with a maximum of 2 outlets at a flow rate of 11.7 mL/min. Lower flow rates may also yield laminar flow conditions. As shown in FIGS. 6A-6F, a laminar flow is achieved in these given configurations. FIGS. 6G-6H displaying the configuration with one inlet and three outlets does not achieve laminar flow. Accordingly, biodomes with three outlets may fail to sweep the entire headspace under this configuration, leaving volumes of stagnant air. However, alternative device specifications such as inlet/outlet diameter, inlet/outlet positioning, and flow rate may not yield turbulent flow. Accordingly, multiple device specifications have been shown to produce laminar flow, which is ideal for improving sampling reproducibility across laboratories.

### Example 5—Fluid Modeling within Multiplex Part Under Experimental Conditions

Methods. ANSYS fluid modeling software was used to demonstrate expected flow characteristics of a fluid within the multiplex part with varying inlet sizes as described herein. The precise geometry and experimental flow conditions were used as inputs to generate the fluid flow model. An inlet flow rate of 35.4 mL/min was used to allow for an outlet flow of approximately 11.8 mL/min. The multiplex parts tested have an increasing inlet size across the experiments, ranging from ¼ in, ½ in, ¾ in, to 5/4 in. The outlet size remains static during the experiment.

### Flow Profile

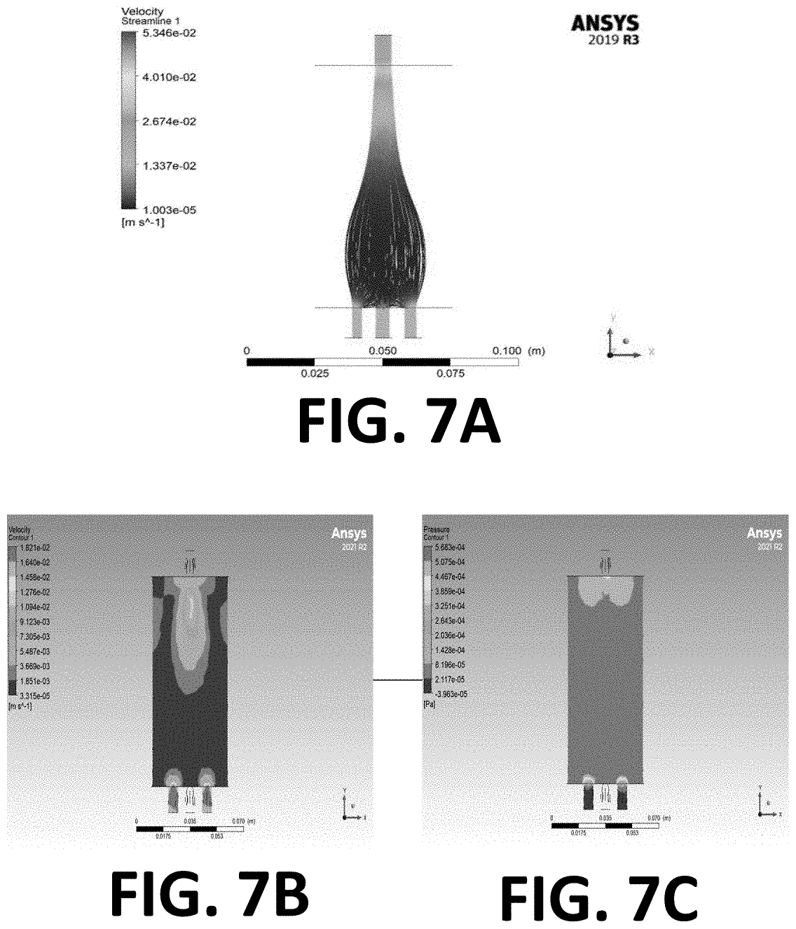

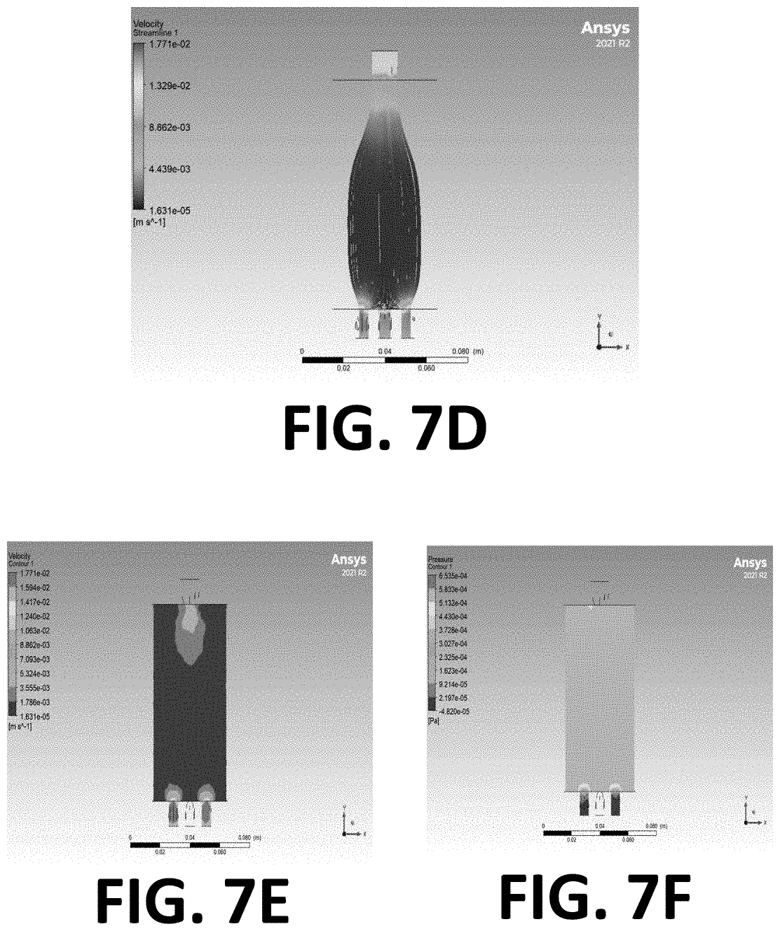

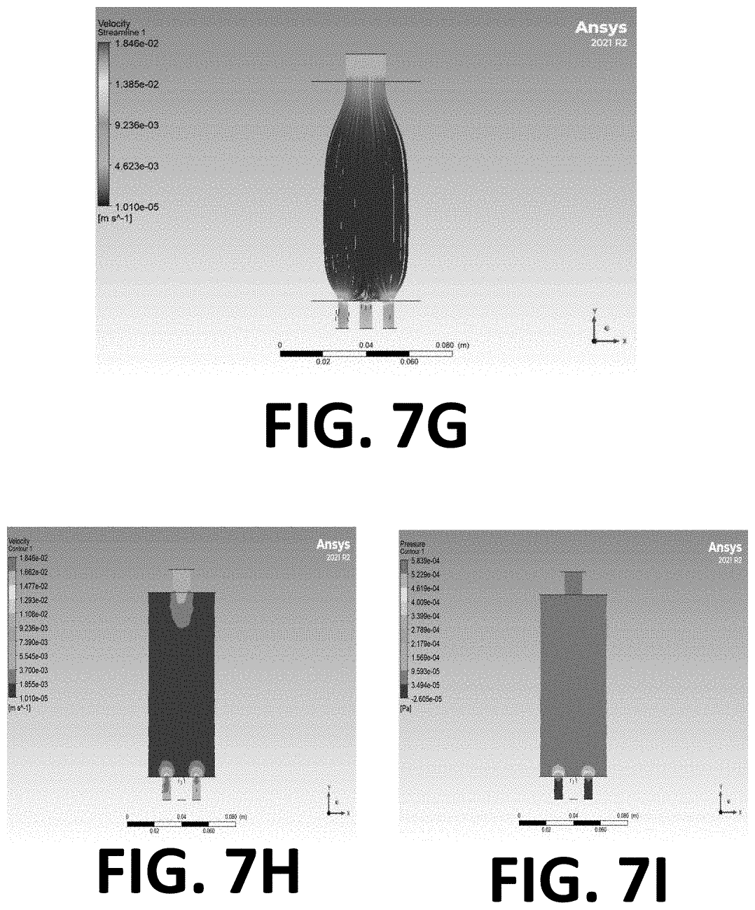

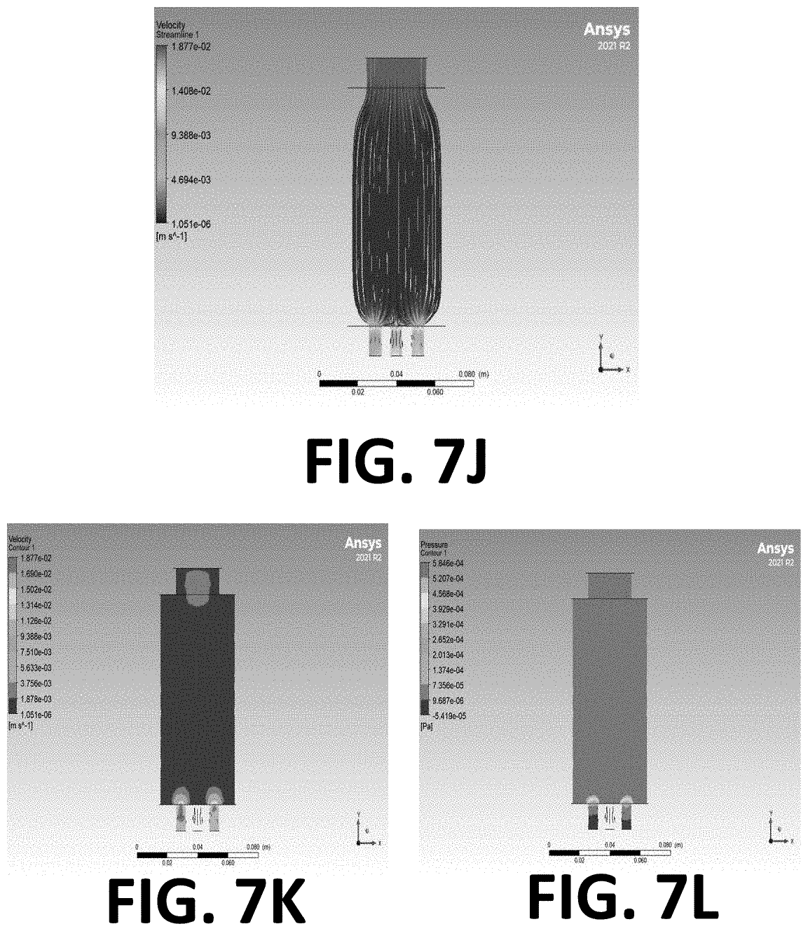

Results. FIGS. 7A, 7D, 7G, AND 7J depict side views of the fluid (gas) flow profile in the multiplex part with an inlet size of ¼ in, ½ in, ¾ in, and 5/4 in, respectively. The fluid is shown to have laminar flow and equal distribution across the outlets under experimental conditions, which is ideal for verifying the flow rate is standardized and reproducible across the attached collection devices.

### Pressure and Velocity Profiles

Results. FIGS. 7B, 7E, 7H, 7K depict the velocity contour profile through the center of the multiplex part device along the X-Y plane. FIGS. 7C, 7F, 7I, 7L depict the pressure contour profile through the center of multiplex part along the X-Y plane. The results indicate an equal distribution of pressure across the various inlet sizes of the multiplex part. Additionally, the results indicate the velocities for the outlets remain similar across the multiplex parts with varying inlet size.

### Example 6—Analysis of VOCs Collected from SKOV-3 Ovarian Cancer Cells

Methods. A compressed gas tank containing 5% CO2/95% Air was connected to a biodome collection system with living SKOV-3 ovarian cancer cells (or microbes) and cell media. The gas tank was connected to the biodome using PTFE tubing (¼″ OD; ⅛″ ID), nuts and adaptors, Teflon tape at tubing/inlet junctions to seal minor leaks, a gas flow meter, hydrocarbon trap, and a rubber stopper at the system outlet. Thermal Desorption Tubes with Carbopack C, Carbopack B and Carbosieve S-III sorbent packs were connected to the biodome outlet. The biodome was placed on a copper sheet (⅛″ thickness) within a bead bath set to 37° C. A bubble leveler was used to ensure the copper sheet was lying flat such that the biodome was substantially level.

The thermal desorption tubes packed with Carboback C, Carbopack B, and Carbosieve S-III sorbent packs were loaded with 2 L of headspace using a flow rate of 5 mL/min (5% CO2/95% Air). VOCs were collected for a total of 24 continuous hours. VOCs were extracted from the thermal desorption tubes using a Thermal Desorption Unit (Gerstel, Inc.) and assessed using a comprehensive two-dimensional gas chromatograph coupled with a time-of-flight mass spectrometer (Pegasus 4D GCxGC-TOFMS; LECO Corp.).

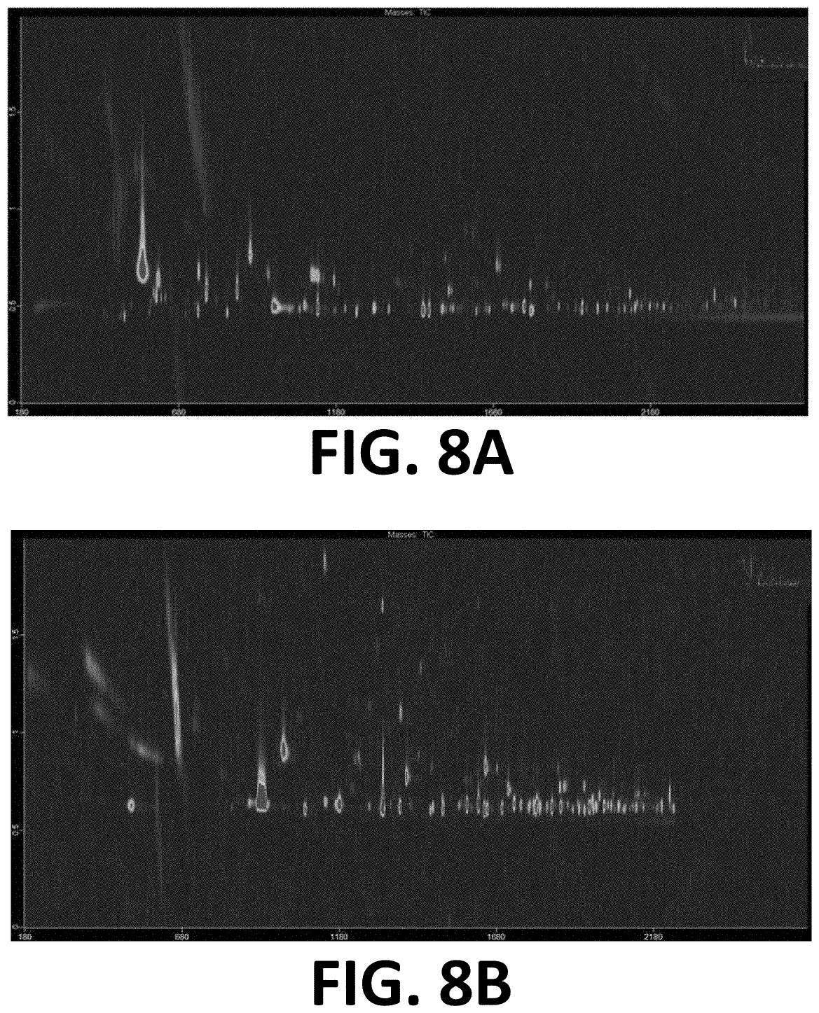

Results. FIGS. 8A-8B depict raw 3D chromatograms generated from the thermal desorption tubes. The chromatogram of FIG. 8A was generated from the thermal desorption tube containing VOCs collected during the first 6 hours in the flow system. The chromatogram of FIG. 8B was generated from the thermal desorption tube contained VOCs collected during the last 6 hours, i.e., hours 19-24. Table 1 summarizes the experimental methods. Table 2 summarizes the post-processing information from each test, such as detected features, duplicate features, background contamination, and possible cell VOCs.

TABLE 1
Summary of experimental methods for VOC Analysis of Example 4.

| | Flow | Flow | Equivalent | | Number of | Total Collection |
|---|---|---|---|---|---|---|
| Test | Time (hrs) | Reading | Flow Rate | | Samples | Time (hrs) |
| 1 | 6 | 15 | ~6 | ml/min | 4 | 24 |
| 2 | 6 | 15 | ~6 | ml/min | 4 | 24 |
| 3 | 6 | 20 | ~8 | ml/min | 4 | 24 |
| 4 | 6 | 20 | ~8 | ml/min | 4 | 24 |
| 5* | 6 | 20 | ~8 | ml/min | 4 | 24 |
| 6 | 6 | 20 | ~8 | ml/min | 4 | 24 |
| 7** | 6 | 20 | ~8 | ml/min | 4 | 24 |
| Blank 1*** | 6 | 20 | ~8 | ml/min | 2 | 12 |
| 8** | 6 | 20 | ~8 | ml/min | 4 | 24 |
| 9 | 1-5 | 20 | ~8 | ml/min | 9 | 25 |
| 70 mm, 9 hours | 9 | 25 | ~11.8 | ml/min | 1 | 9 |
| 70 mm, 12 hours | 12 | 25 | ~11.8 | ml/min | 1 | 12 |
| 70 mm, 6 hours | 6 | 25 | ~11.8 | ml/min | 1 | 6 |

Key:
*= Samples stored for 1 week prior to analysis;
**= Samples analyzed using 4 different gas chromatography methods;
***= N₂ gas flow limited and may affect conditioning of desorption tubes.

TABLE 2
Summary of post-processing information from VOC Analysis of Example 4, including post-
processing information, detected features, duplicate features, and possible cell VOCs.

| | | | Post-Clean Up | | | | |
|---|---|---|---|---|---|---|---|
| | Post-Alignment | | | | Unique | Results | |
| | Features | Total | Duplicate | | Identified | | Possible |
| Test | in All | Features | Features | Unknowns | Features | Siloxanes | Cell VOCs |
| 1 | 240 | 634 | 223 | 153 | 258 | 54 | 204 |
| 2 | 102 | 159 | 82 | 32 | 45 | 22 | 23 |
| 3 | 199 | 334 | 133 | 82 | 119 | 48 | 71 |
| 4 | 194 | 444 | 222 | 67 | 155 | 31 | 124 |
| 5* | 47 | 205 | 79 | 39 | 87 | 19 | 68 |
| 6 | 210 | 431 | 185 | 114 | 132 | 27 | 105 |
| 7** | 55 | 285 | 118 | 64 | 103 | 24 | 79 |
| Blank 1*** | 88 | 271 | 101 | 46 | 124 | 36 | 88 |
| 8** | 0 | 162 | 50 | 97 | 15 | 3 | 12 |
| 9 | X | X | X | X | X | X | X |
| 70 mm, 9 hours | N/A | 1264 | 342 | 212 | 710 | 121 | 589 |
| 70 mm, 12 hours | N/A | 964 | 262 | 245 | 457 | 95 | 362 |
| 70 mm, 6 hours | N/A | 781 | 249 | 207 | 325 | 59 | 266 |

Key:
*= Samples stored for 1 week prior to analysis;
**= Samples analyzed using 4 different gas chromatography methods;
***= N₂ gas flow limited and may affect conditioning of desorption tubes;
X = Sample not analyzed.

### Example 7—Identification of VOCs from Chromatography Peaks

Methods. Three samples were used for collection of VOCs: a first sample of SKOV-3 ovarian cancer cells grown in cell culture media supplemented with 13C-D-glucose in order to label the cancer cells with isotopic carbon (i.e., ‘Condition 1’); a second sample of SKOV-3 ovarian cancer cells grown in cell culture media under normal conditions with common 12C-D-glucose (i.e., ‘Condition 2’); and a negative control (only culture media). Each sample was maintained in a separate biodome. VOCs were collected from the samples in thermal desorption tubes in a manner as described (e.g., see Example 3). VOCs were collected continuously, in 12 hour increments, over a total collection period of 3 days. VOCs were then at each of the time increments extracted from the thermal desorption tubes using a Thermal Desorption Unit (Gerstel, Inc.) and assessed using a comprehensive two-dimensional gas chromatograph coupled with a time-of-flight mass spectrometer (Pegasus 4D GCxGC-TOFMS; LECO Corp.). The raw 3D chromatograms were processed to align chromatographic peak information across the samples and match the mass spectral information to known chromatographic peaks for VOCs according to the 2011 National Institute of Standards and Technology (NIST) database. Accordingly, VOCs were identified in the collected samples based on their chromatographic peaks.

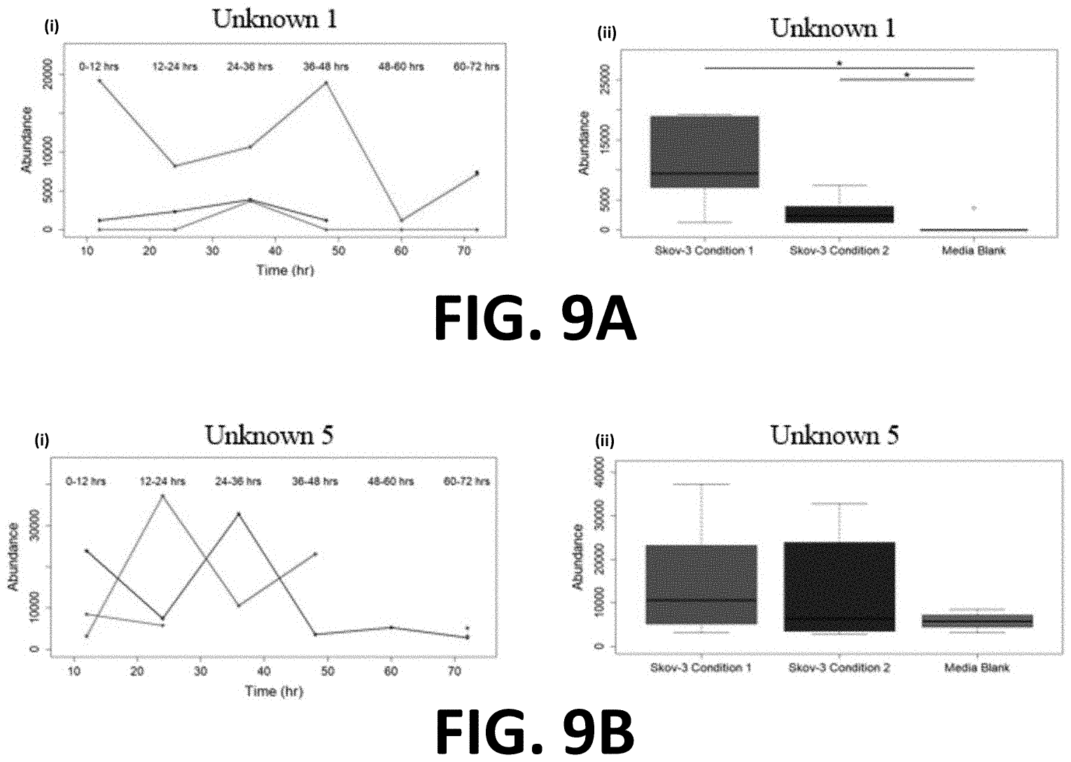

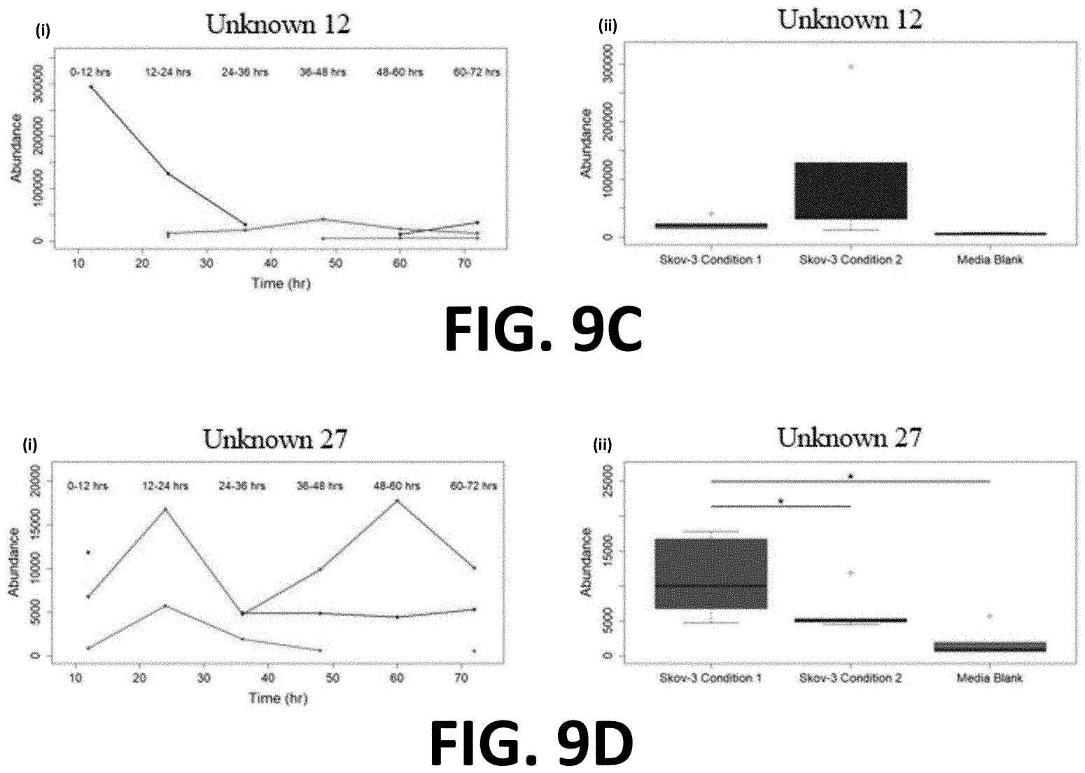

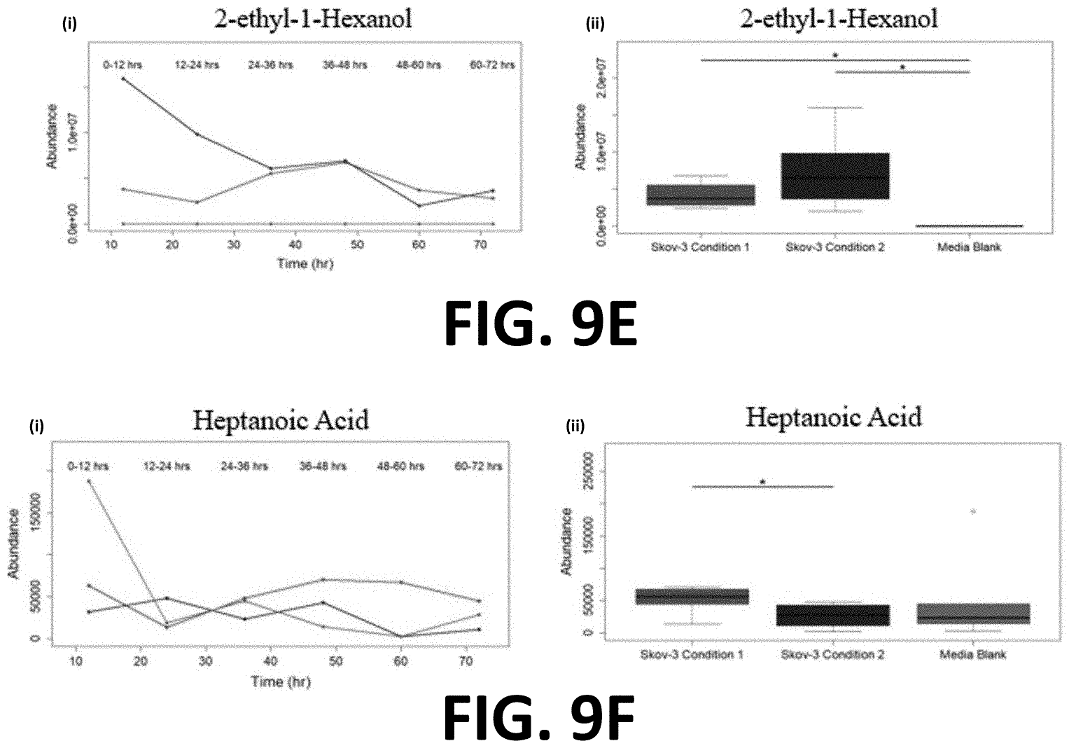

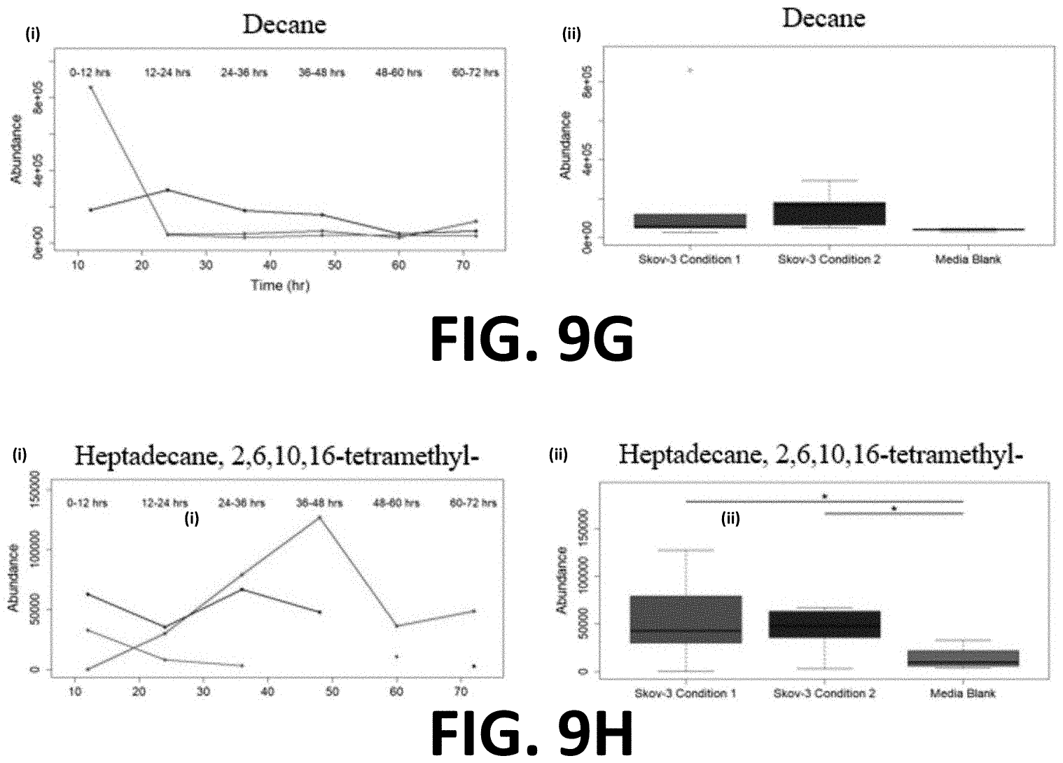

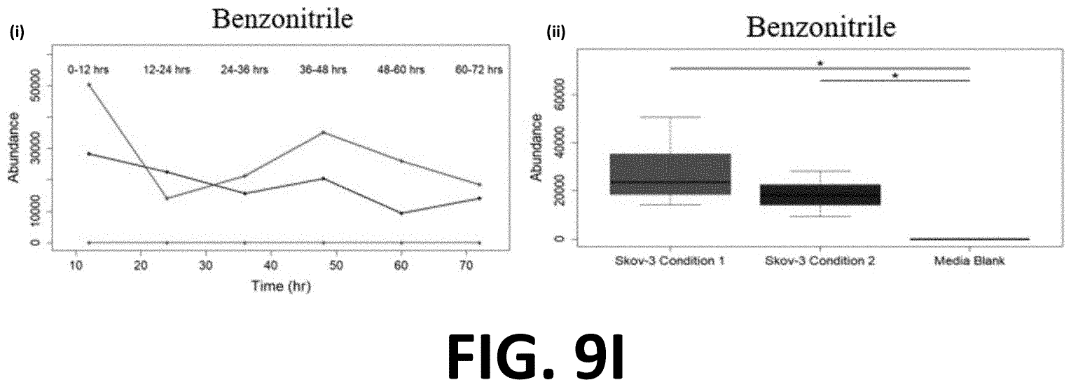

Results. FIGS. 9A-9I depict volatile organic compound abundance results for several detected VOCs across the samples. VOCs that fell below chromatographic and mass spectral naming thresholds were assigned the name “Unknown” (see FIGS. 9A-9D). Identified VOCs include 2-ethyl-1-Hexanol (FIG. 9E); Heptanoic acid (FIG. 9F); Decane (FIG. 9G); 2,6,10,16-trimethyl-Heptadecane (FIG. 9H); and Benzonitrile (FIG. 9I). For each of FIGS. 9A-9I, raw instrument abundance values (y-axis) are plotted over time (x-axis) in graph (i). Further, boxplots are shown which summarize VOC abundance across the 3 days of experimentation in graph (ii). From this proof-of-concept experiment, at least four VOCs were identified which were (statistically) significantly upregulated in the experimental conditions with cells compared to the negative control. A one-sided two sample t-test with α=0.05 was performed to determine statistical significance, assuming unequal variance between sample conditions. Multiple hypothesis testing correction was performed by setting the false discovery rate (FDR)=0.15 and VOCs that retained significance are indicated by a star (*). Furthermore, the labeling of the Condition 1 sample with 13C-D-glucose may allow validation of the endogenous production of VOCs by the cells using mass spectrometry techniques as would be apparent to a person having an ordinary level of skill in the art.

### Example 8—Live/Dead Assay Through the Biodome Collection Device

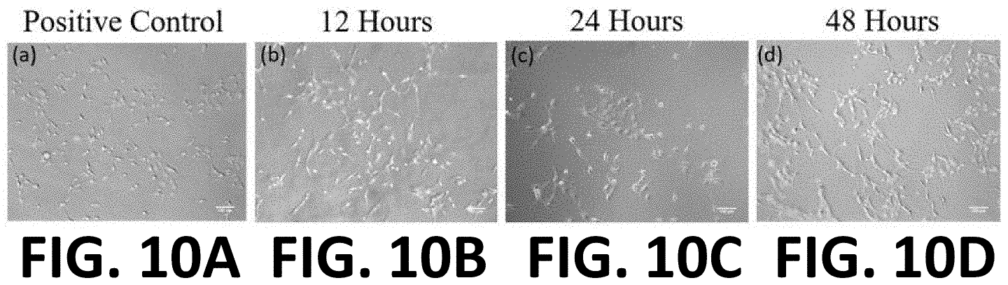

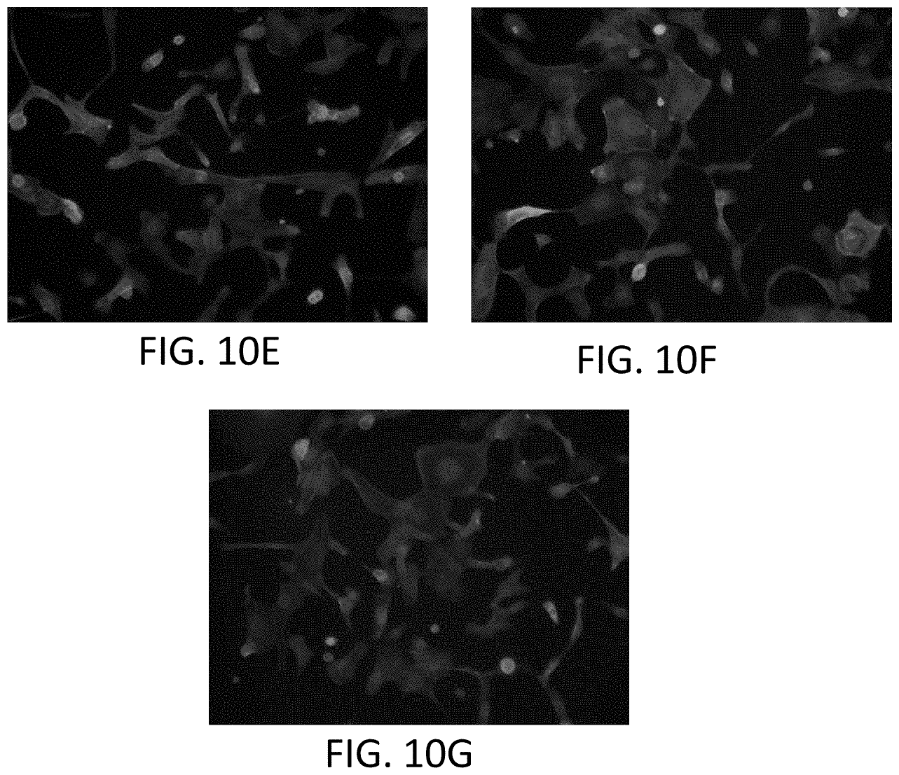

Methods. SKOV-3 ovarian cancer cells within the biodome were imaged and a live/dead assay was performed on the cells at multiple intervals. A positive control sample containing SKOV-3 cells cultured in a biodome and grown in a standard incubator. Three test samples of SKOV-3 cells were cultured in separate biodomes with VOC collection over varying durations. In a first test sample, VOC collection occurred over a period of 12 hours. In a second test sample, VOC collection occurred over a period of 24 hours. In a third test sample, VOC collection occurred over a period of 48 hours. Nuclear staining was applied to the cells for the live/dead assay. Hoechst 33342 was applied to live cells to stain with green fluorescence and SYTOX Green was applied to dead cells to stain with red fluorescence. Images were collected on a Nikon Eclipse TS2R using a 10× objective. Results are shown in FIGS. 10A-10D. Live morphology staining was also performed in the Biodome using SKOV-3 cells. Cells were stained with CellMask Deep Red Actin Tracking Stain, Invitrogen (Actin; green color), Hoechst 33342 (nuclear live stain; blue color), and SYTOX Green (nuclear dead stain; red color). Results are shown in FIGS. 10E-10G.

Results. FIGS. 10A-10G depict the live/dead assay results. FIG. 10A depicts the positive control sample. FIG. 10B depicts the first test sample that underwent 12 hour VOC collection. FIG. 10C depicts the second test sample that underwent 24 hour VOC collection. FIG. 10D depicts the third test sample that underwent 48 hour VOC collection. The combined overlay consists of a bright field image, “live” cell image (shown in green), and “dead” cell image (shown in red). The images demonstrate that the vast majority (>99%) of cells grown in the biodome are alive and viable for further experimentation and VOC collection. FIGS. 10E-10G depict the live morphology staining performed using SKOV-3 cells confirming the presence of live nuclei and further confirming viability for cells grown in the biodome. The actin cytoskeleton is captured by the green fluorescent signal, and validates the SKOV-3 cells had a standard epithelial cell morphology, indicating normal growth properties. These images also demonstrate the dual imaging capability within the biodome collection device.

### Example 9—Cell Adhesion Assay in the Biodome Collection Device

Methods. Cell adhesion was tested by applying cells to the glass surface of the biodome collection device with various different conditions. A collagen treatment, a fibrinogen treatment, an acid/base wash treatment, and a control (no treatment) were tested. Cells were applied to the glass surface and allowed to adhere.

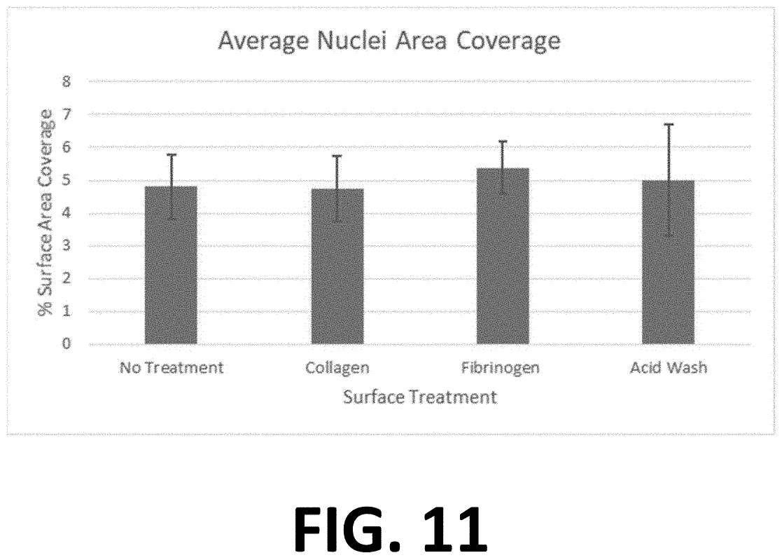

Results. The treatments were assessed based on the amount of surface area coverage of the glass surface achieved by the cells. FIG. 11 depicts the average nuclei area coverage for each surface treatment. As shown, various adhesion proteins and/or an acid/base wash did not significantly improve cell adhesion in the biodome. This finding is beneficial because repeat experiments in the biodome collection device do not require surface treatment beforehand, thereby reducing overall cost and experiment time

### Example 10—Analysis of VOCs Collected from Anaerobic Bacteria: Streptococcus pneumoniae

Methods. A compressed gas tank containing a Specialty Gas Mix (5% CO2/95% Air) was connected to a biodome collection system with living anaerobic bacteria Streptococcus pneumoniae and cell media. The gas tank was connected to the biodome using PTFE tubing (¼″ OD; ⅛″ ID), nuts and adaptors, Teflon tape at tubing/inlet junctions to seal minor leaks, a gas flow meter, hydrocarbon trap, and a rubber stopper at the system outlet. Solid phase micro-extraction (SPME) fibers were connected to the biodome outlet. The biodome was placed on a copper sheet (⅛″ thickness) within a bead bath set to 37° C. A bubble leveler was used to ensure the copper sheet was lying flat such that the biodome was substantially level.

The SPME fibers were loaded with 2 L of headspace using a flow rate of 11.7 mL/min ((5% CO2/95% Air). VOCs were collected for a total of 72 continuous hours with the SPME fibers replaced every 24 hours. VOCs were extracted from the SPME fibers using a standard GC Inlet and assessed using an Agilent 6890N gas chromatograph coupled with 5973N Mass spectrometer.

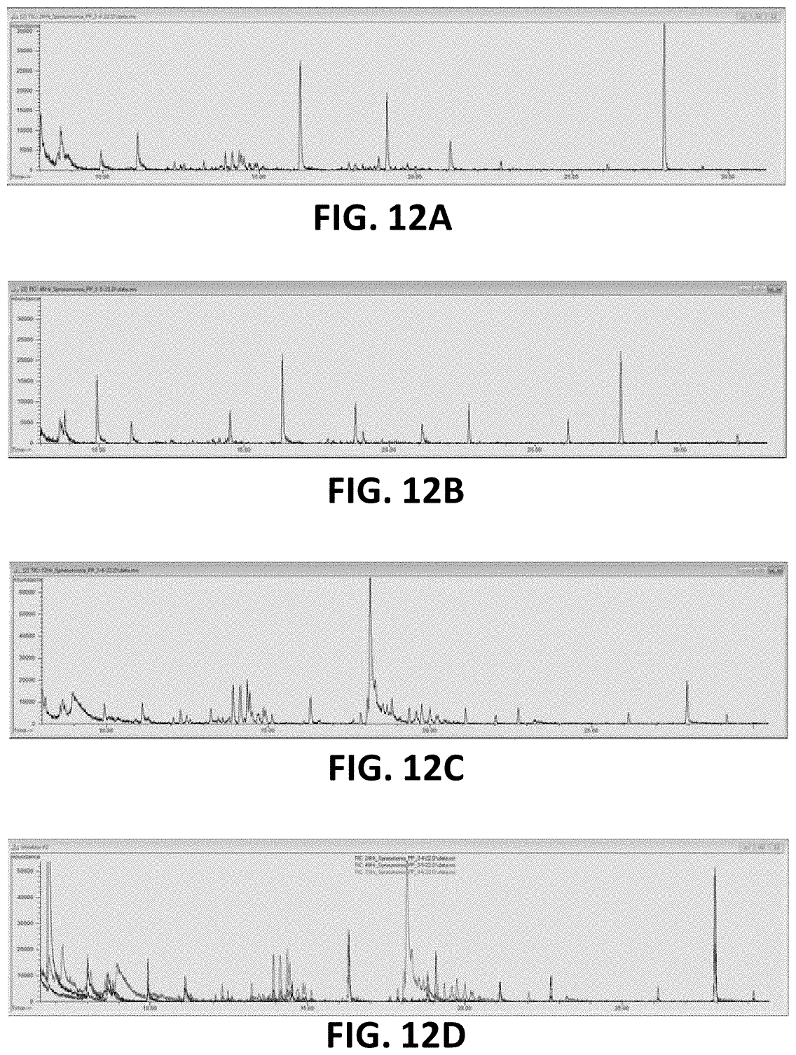

Results. Analysis performed on an Agilent 6890N gas chromatograph and an Agilent 5973N Mass Spectrometer VOC sampling was performed using SPME fibers to allow for standard GC-MS analysis. FIGS. 12A-12C depict raw chromatograms generated from the SPME fibers. The chromatogram of FIG. 12A was generated from the SPME fibers containing VOCs collected during the first 24 hours in the flow system. The chromatogram of FIG. EB was generated from VOC's collected during the 24-48 hour period. The chromatogram of FIG. 12C was generated from VOC's collected during the 48-72-hour period. The chromatograph of FIG. 12D is an overlay of the data found in FIG. 12A-12C.

### Example 11—Analysis of VOCs Collected from Anaerobic Bacteria: Enterococcus faecalis

Methods. A compressed gas tank containing a Specialty Gas Mix (5% H2/20% CO2/75% N2) was connected to a biodome collection system with living anaerobic bacteria Enterococcus faecalis and cell media. The gas tank was connected to the biodome using PTFE tubing (¼″ OD; ⅛″ ID), nuts and adaptors, Teflon tape at tubing/inlet junctions to seal minor leaks, a gas flow meter, hydrocarbon trap, and a rubber stopper at the system outlet. SPME fibers were connected to the biodome outlet. The biodome was placed on a copper sheet (⅛″ thickness) within a bead bath set to 37° C. A bubble leveler was used to ensure the copper sheet was lying flat such that the biodome was substantially level.

The SPME fibers were loaded with 2 L of headspace using a flow rate of 11.7 mL/min ((5% H2/20% CO2/75% N2). VOCs were collected for a total of 72 continuous hours with the SPME fibers replaced every 24 hours. VOCs were extracted from the SPME fibers using a Standard GC inlet (Agilent) and assessed using an Agilent 6890N gas chromatograph coupled with 5973N Mass spectrometer.

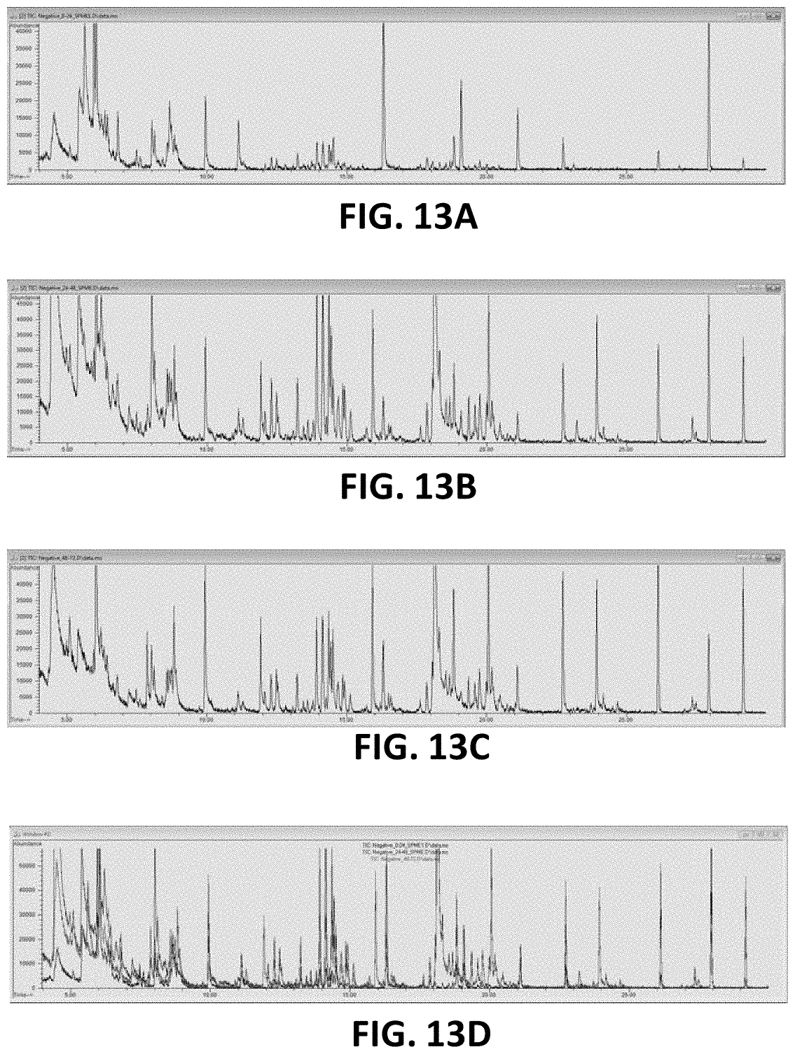

Results. Analysis performed on an Agilent 6890N gas chromatograph and an Agilent 5973N Mass Spectrometer VOC sampling was performed using SPME fibers to allow for standard GC-MS analysis. FIGS. 13A-13C depict raw chromatograms generated from the SPME fibers. The chromatogram of FIG. 13A was generated from the SPME fibers containing VOCs collected during the first 24 hours in the flow system. The chromatogram of FIG. 13B was generated from VOC's collected during the 24-48 hour period. The chromatogram of FIG. 13C was generated from VOC's collected during the 48-72-hour period. The chromatograph of FIG. 13D is an overlay of the data found in FIG. 13A-13C.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Instead, this application is intended to cover any variations, uses, or adaptations of the present teachings and use its general principles. Further, this application is intended to cover such departures from the present disclosure as come within known or customary practice in the art to which these teachings pertain. Many modifications and variations can be made to the particular embodiments described without departing from the spirit and scope of the present disclosure as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A collection device for collecting VOCs from a living biological sample, the collection device comprising:
a housing comprising an upper surface, a lower surface, and a substantially circular sidewall extending between the upper surface and the lower surface;
an interior chamber comprising a substantially cylindrical volume defined between the upper surface, the lower surface, and the circular sidewall, wherein the interior chamber is configured to receive the living biological sample;
one or more inlets extending through the upper surface and fluidly communicating with the interior chamber; and
one or more outlets extending through the upper surface and fluidly communicating with the interior chamber, wherein the one or more outlets are substantially diametrically opposed to the one or more inlets with respect to the cylindrical volume,
wherein the collection device is configured to pass fluid in a substantially laminar flow path through the one or more inlets, across the interior chamber, and out of the one or more outlets,
wherein at least one of the upper surface, the lower surface, and the circular sidewall comprises a substantially transparent material configured to transmit light therethrough.

2. The collection device of claim 1, wherein the one or more inlets are disposed about 0.4 cm from the circular sidewall and have a diameter of about 0.645 cm (¼ in).

3. The collection device of claim 1, wherein the one or more outlets are disposed about 1.0 cm from the circular sidewall and have a diameter of about 1.8 cm.

4. The collection device of claim 1, wherein each of the inlet and the outlet comprises a tubular channel having a height of about 1 cm extending upward from the upper surface.

5. The collection device of claim 1, further comprising one or more ports extending through the upper surface and fluidly communicating with the interior chamber.

6. The collection device of claim 1, wherein the one or more ports are disposed 1.0 cm from the circular sidewall and have a diameter of about 1.25 cm.

7. The collection device of claim 1, further comprising one or more inlet caps including one or more openings configured to permit fluid flow through the one or more inlets.

8. The collection device of claim 1, further comprising one or more outlet caps including one or more openings configured to permit fluid flow through the one or more outlets.

9. The collection device of claim 1, wherein the housing is configured to withstand autoclaving.

10. The collection device of claim 1, wherein the housing is heat treated to reduce background VOC release.

11. The collection device of claim 1, wherein the substantially transparent material comprises borosilicate glass.

12. The collection device of claim 1, wherein the cylindrical volume comprises a diameter of about 7.0 cm and a height of about 1.3 cm.

13. A fluid flow system for collecting VOCs from a living biological sample, the fluid flow system comprising:
a collection device including:
a housing comprising an upper surface, a lower surface, and a substantially circular sidewall extending between the upper surface and the lower surface,
an interior chamber comprising a substantially cylindrical volume defined between the upper surface, the lower surface, and the circular sidewall, wherein the interior chamber is configured to receive the living biological sample,
one or more inlets extending through the upper surface and fluidly communicating with the interior chamber; and
one or more outlets extending through the upper surface and fluidly communicating with the interior chamber, wherein the one or more outlets are substantially diametrically opposed to the one or more inlets with respect to the cylindrical volume;
a compressed gas source in fluid communication with the interior chamber of the collection device via the one or more inlets and configured to emit gas to the interior chamber to displace a volume of headspace from the interior chamber; and
a fluid flow meter in fluid communication with the compressed gas source and the interior chamber, the fluid flow meter configured to regulate a flow rate of gas from the compressed gas source to the interior chamber,
wherein the gas emitted to the interior chamber and the volume of headspace displaced from the interior chamber flow along a substantially laminar flow path through the interior chamber.

14. The fluid flow system of claim 13, further comprising a hydrocarbon trap in fluid communication with the compressed gas source and the interior chamber, the hydrocarbon trap configured to remove hydrocarbon impurities from the gas upstream of the interior chamber.

15. The fluid flow system of claim 13, wherein the compressed gas source comprises a mixture of gases.

16. The fluid flow system of claim 13, wherein the fluid flow meter is configured to regulate the flow rate from about 10 mL/min to about 50 mL/min.

17. The fluid flow system of claim 13, wherein the collection device is disposed in a bath, wherein the bath is configured to maintain the temperature in the interior chamber from about 0° C. to about 100° C.

18. The fluid flow system of claim 13, wherein the collection device, the compressed gas source, and the fluid flow meter are connected by one or more PTFE tubes.

19. The fluid flow system of claim 13, wherein a gas source is connected to a multiplex part that allows for the delivery of gas to more than one system of claim 13 for parallel experimentation.

20. The fluid flow system of claim 13, further comprising a thermal desorption tube in fluid communication with the interior chamber via the one or more outlets, the thermal desorption tube configured to collect the displaced volume of headspace from the interior chamber and capture VOCs from the displaced volume of headspace.
